(19) United States
(12) Patent Application Publication
(10) Pub. No.: US 2004/0177071 A1
(43) Pub. Date: Sep. 9, 2004

(54) System and method for outcome-based management of medical science liaisons

(76) Inventors: Bill Wayne Massey, Ramona, CA (US); Daniel Joseph Cushing, Phoenixville, PA (US); Daniel John Leonard, Lansdowne, PA (US)

Correspondence Address: FOX ROTHSCHILD O'BRIEN & FRANKEL LLP, PRINCETON PIKE CORPORATE CENTER, 997 LENOX DRIVE, BUILDING 3, LAWRENCEVILLE, NJ, 08648, US

(21) Appl. No.: 10/379,227

(22) Filed: Mar. 4, 2003

(51) Int. Cl. G06F 7/00

(52) U.S. Cl. 707/7

(57) ABSTRACT

A system and method for managing customer interaction activities of medical liaison personnel of a sponsor organization with health professional customers to achieve one or more desired business outcomes is disclosed. The system uses a customer relation database to record data regarding customer interaction activity of the medical liaison personnel and data regarding the business outcomes achieved or not achieved during the predetermined time period. The system correlates the customer interaction activity data and the business outcome data so that it can be used to conduct capacity and tactical assessments for future medical liaison activities. A method for targeting medical thought leaders or other health professionals who are most likely to achieve the business outcomes is also disclosed. In one embodiment, the system also provides a method for surveying the health professional customers to determine their level of satisfaction with medical liaison personnel and sponsor organization.

### FIELD OF THE INVENTION

This invention relates to a management system for the efficient management and evaluation of medical support groups in the pharmaceutical, bio-pharmaceutical and medical device industries.

### BACKGROUND OF THE INVENTION

Virtually all major pharmaceutical companies have deployed field-based medical support programs. Medical liaison personnel have supported a range of customers, including medical thought leaders (MTL), investigators, and health care decision makers. The necessity of support will increase with technological advances, consolidation of decision making, and the increasing complexity of health care decisions.

Field-based medical support programs were established as a result of the necessity for more knowledgeable personnel to support and advise the medical industry. Initially, a small group of technically-oriented sales representatives was formed with the goal of improving the image of the company with researchers, key opinion leaders, and investigators. These medical science liaisons (MSLs), as they were known, utilized face-to-face peer interactions to better understand what their customers needed and to leverage products into ongoing research activities.

Today, professionals having advanced degrees constitute the majority of pharmaceutical company medical personnel. As a result of their advanced education, training, and clinical experience, field-based medical personnel are regarded as more knowledgeable than pharmaceutical company sales representatives and account executives and are favored by some customer segments in clinical peer discussions. The services offered by field-based medical personnel have evolved over time with the increasing complexity of marketed products and customer medical information and education needs.

Due to the changes in patient treatment options today, field-based medical liaisons work with a continually changing mix of opinion leaders and decision makers. Although most health care providers are interested in traditional safety and efficacy information, some seek information on health economic/pharmacoeconomic analyses, outcomes, disease management information, and clinical programs (i.e. treatment algorithms, practice guidelines, and care mapping). Ultimately, they desire this data for their own practice setting or environment in order to reflect the clinical and cost structures unique to their patient mix.

Until now, there has been little or no means available for assessment of the impact of MSL activity on the sponsor company's business objectives. Internal evaluation, if any, has been typically limited to merely recording the activities of the individuals on a MSL team.

Consequently, there is a need for a system to optimize the management of an MSL team and establish business metrics (measuring elements) to accurately track the MSL team activities, track the time spent performing various tasks and in customer interaction, and measure the business impact of the MSL team.

### SUMMARY OF THE INVENTION

The present invention is a system that provides a means to generate business metrics that enable the MSL team to plan for and manage their activities, effectively allocate resources, and measure their accomplishments. The assignment of specific business outcomes toward a targeted MTL allows for the MSL team's efforts to be incorporated into the sponsor company's overall business planning process and business objectives.

The methods of the present invention may be used by pharmaceutical company in determining the appropriate use of access channels to the customer. The metrics derived from the methods of the present invention enable executive management to optimally allocate resources across customer-interfacing groups within the organization in order to achieve vital business objectives.

The methods of the present invention are organized into a cyclic process consisting of three phases: Planning, Executing, and Evaluating.

The Planning phase provides methods for determining “real world” MSL capacity, MTL targeting and selection, incorporating MSL business objectives in support of the sponsor company's overall business strategy, and defining performance metrics.

During the Executing phase, the system provides for the assessment of performance and documentation of MSL activities. This information is summarized to produce the targeted customer lists (TCL) and to efficiently focus the resources of the sponsor company.

The Evaluating phase involves assessment of MSL impact through analysis of achieved business outcomes, MSL-specific surveys of targeted MTLs, impact on prescribing behavior of targeted MTLs and their influence network, and analysis of the value provided by the MSL's internal activities (training sales, reviewing protocols, etc.). The outputs of the Executing phase's activity assessment and Evaluation phase allow for refinement of future planning and execution, thereby providing a cyclic system for continuous business improvement.

A system and method for managing customer interaction activities of medical liaison personnel of a sponsor organization with health professional customers to achieve one or more desired business outcomes is disclosed. The system uses a customer relation database to record data regarding customer interaction activity of the medical liaison personnel and data regarding the business outcomes achieved or not achieved during the predetermined time period. The system correlates the customer interaction activity data and the business outcome data so that it can be used to conduct capacity and tactical assessments for future medical liaison activities. A method for targeting medical thought leaders or other health professionals who are most likely to achieve the business outcomes is also disclosed. In one embodiment, the system also provides a method for surveying the health professional customers to determine their level of satisfaction with medical liaison personnel and sponsor organization.

### BRIEF DESCRIPTION OF THE DRAWINGS

FIG. 1 is a schematic of the relationship of the data structures, execution phase and evaluation output.

FIG. 2 is a schematic of the planning, execution and evaluation phases.

FIG. 3 is a flow chart diagram of a preferred embodiment of the method of the present invention.

### DETAILED DESCRIPTION OF THE INVENTION

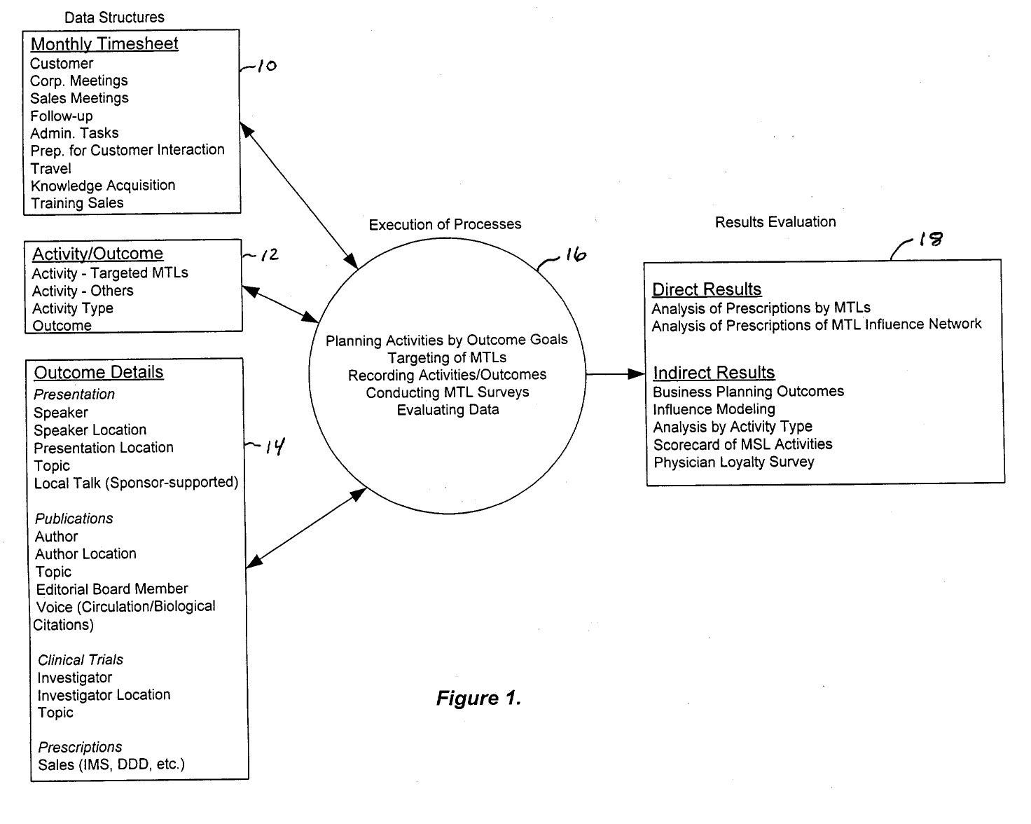

With reference to FIGS. 1 through 3, the flow path relationship of the activities of the planning, execution and evaluation phases will be based on the desired information needed to obtain a specific business objective. The activities of the MSLs in each phase and the evaluation of the information obtained by these activities is discussed herein.

FIG. 1 shows an illustration of data structures, execution sub-processes and evaluation output. Block 10 shows examples of data types to be tracked in a customer relation database table from MSL timesheets. Block 12 is a sample data structure for and MSL Activity/Business Outcome table and block 14 is a sample data structure for data relating to Outcome Details. The data may be recorded in a relational database as is well known in the art. Circle 16 illustrates an overview of the sub-processes executed by the sponsor organization (or the consultants or outside advisers) of the present system. Data is collected regarding the MTLs, the activities of the MSLs, the business outcomes achieved or not achieved, and MTK satisfaction. This data is recorded in a database or databases and may be used for planning or evaluation of the impact of the MSL activities on the sponsor organization business objectives. Block 18 illustrates types of output from the databases that may be used by the management of the sponsor organization to analyze the results of MSL activities.

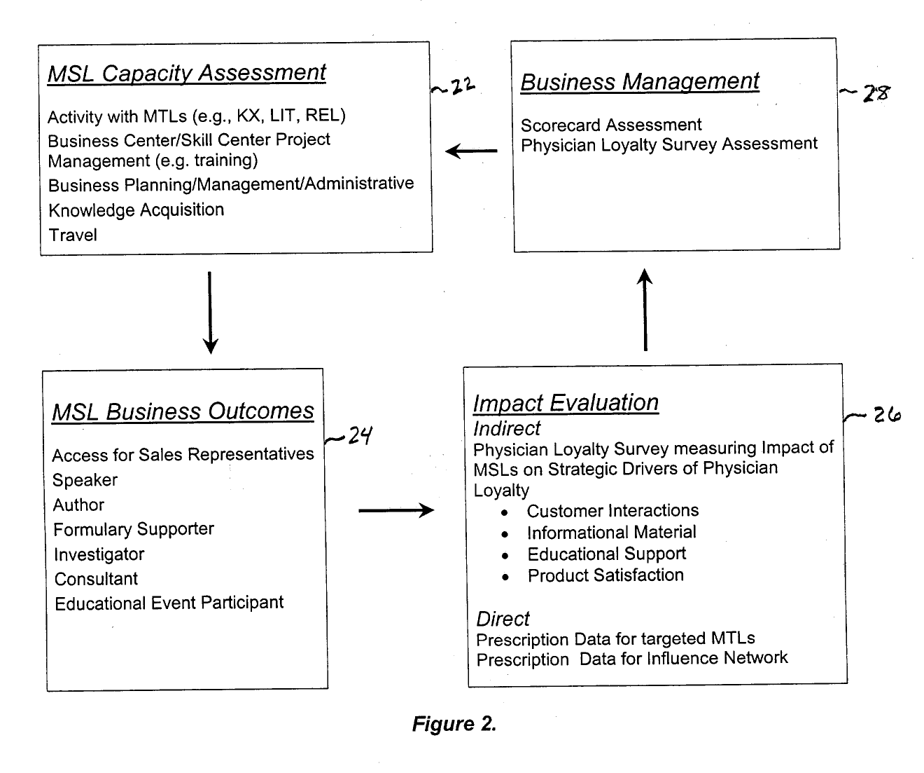

FIG. 2 illustrates the iterative nature of the system. Block 22 lists sample factors for assessing the capacity of an MSL team for a predetermined time period such as a month, calendar quarter or year. Once capacity has been determined, it is correlated to desired business outcomes such as those set forth in block 24. After the plan has been executed, the sponsor organization management can evaluate the impact of the MSL activity on the business outcomes as illustrated in block 26. The measures of business outcome correlated with activity data can then be assessed and used by management as shown in block 28 and used to establish plans for future capacity allocation and tactical planning.

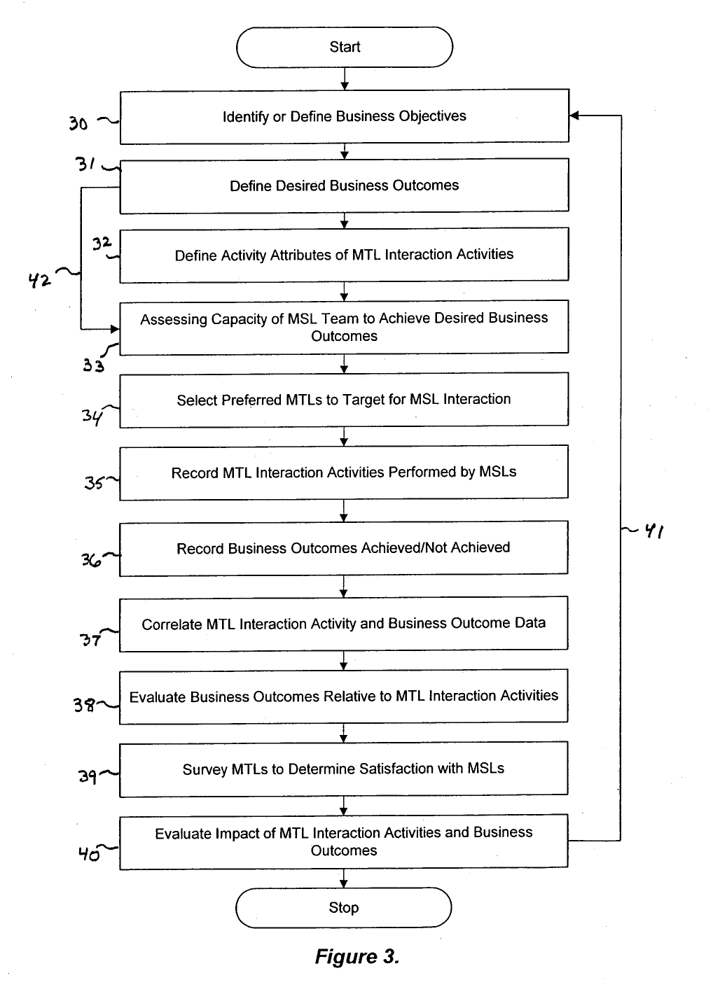

A preferred embodiment of the method of the present invention is illustrated in FIG. 3. In step 30, the sponsor organization's business objectives are established. Typically, these objectives would conform to generally accepted industry objectives. Desired business outcomes of the MSL activity such as those set forth in detail below are defined in step 31. The types or attributes of MTL interaction activities to be carried out by the MSLs are defined in step 32. In step 33, management assesses the capacity of the MSL team to accomplish the desired business outcomes. To optimize potential success of the plan, specific MTLs are targeted for achieving the business outcomes in step 34. More detail regarding a preferred method of targeting MTLs is set forth below. The MTL interaction activities of the MSL team and the business outcomes achieved or not achieved are recorded in the database for a given time period as shown in steps 35 and 36. The activity and business outcome data are correlated in step 37. In step 38 the business outcomes are evaluated relative to the activities performed. The targeted MTLs are surveyed preferably using the survey method set forth below in step 39 to determine MTL satisfaction with the MSL activities and other factors such as educational support or product. In step 40, the impact of the business outcomes and/or the interaction activities are evaluated relative to the planned business objectives. This evaluation may be used to re-start the overall process as illustrated by arrow 41. Optionally, if no new activity attributes are defined, step 32 may be omitted in subsequent iterations as indicated by arrow 42.

Planning and Executing Phases

The system of the present invention begins with a planning and initialization phase wherein the desired objective of the sponsor company initiates an assessment method for a desired outcome.

Time Tracking/Capacity Assessment and Workload Build-Up

Time tracking is accomplished by implementing a system that allows time spent in a set of time categories to be documented. Generally, a set of time categories is established and each is assigned an activity attribute also known as an Activity Type. Examples of Activity Types and a corresponding activity code are set forth in Table 1.

TABLE 1

| Activity | |
|---|---|
| Code | Activity Type |
| BUSSOL | Business Solution - MSL helps provide a |
| | solution that improves MTL's ability to |
| | utilize the Sponsor's products. |
| MEDSOL | Medical Solution - MSL helps provide a |
| | solution to MTL's disease management |
| | practices. |
| KX | Knowledge Exchange - Interaction focuses on |
| | the exchange of scientific/competitor |
| | information. |
| RECRUIT | Recruit - Engage in conversation with topic |
| | being the MTL participating in a Sponsor event/ |
| | activity (e.g., Investigator, Speaker, |
| | Consultant, Author) |
| COACH | Coach - Coaching; helping prepare MTL |
| | for talk, formulary presentation, |
| | other presentation, etc. |
| REL | Relationship Building - Engaging and |
| | nurturing relationship with knowledge |
| | exchange not being the focus. Interaction |
| | is more social/personal in nature. |
| NET | Networking - Activities that connect customers. |
| | Allows MSL to become the hub for MTL to |
| | MTL/other interactions. |
| ASSESS | Assess - Investigate potential clinical |
| | investigational sites. |

The available categories are not limited to those listed in Table 1, but can be expanded or deleted as necessary to obtain a desired business objective. If an internal tracking system is not available or unable to incorporate the MSL-specific time tracking categories, a computer-based system utilizing commercially available customer relation management (CRM) software for time tracking and resource allocation metrics can be modified for utilization.

In order to determine the amount of time available for engaging in customer interactions, one must first determine the number of days that a MSL has available to meet with customers. Example 1 illustrates a typical capacity calculation for a MSL individual

### EXAMPLE 1

### MSL Capacity Calculation

240 workdays per year minus

15 days Society Meetings (3 mtgs/year);

12 days Team Meetings (quarterly);

4 days Sub-Team Meetings;

4 days Departmental alignment meetings (Quarterly);

10 days ad hoc project meetings with HQ staff;

10 days Advisory Board Meetings (5 mtgs/year);

10 days Professional/career development; and

10 to 15 vacation days equals

165 potential days (i.e. 33 weeks or 69% of their total time)

Upon determining the number of available customer days, one must determine the time spent conducting tasks that take away from time spent in customer interactions.

### EXAMPLE 2

### Time Away From Targeted Customers

0.5 day/week Travel;

0.5 day/week Knowledge Acquisition/Management;

0.5 day/week Project management (e.g., list activity, protocol review etc.);

0.5 day/week Administrative activities (e.g., CRM data input, expenses, routing/scheduling; equals

2 days/week away from customers

Thus, by way of illustration, an MSL will have an average of three days per week available to interact with customers. If one multiplies the number of days per week by the number of available weeks, the days available per year to interact with customers is obtained, e.g., three days times 33 weeks equals 99 days with customers.

Thereafter, the amount of time can be further broken down by the amount of customer interactions that can be conducted per day in the field and, on average, how many times per year each customer should be visited to achieve the sponsor company's objectives.

Again, by way of illustration, experience in the industry has shown that an MSL can have approximately five face-to-face interactions per day on prospective MTLs. Therefore, an MSL could make approximately 500 calls per year (5 calls per day multiplied by the ˜100 available days. If the total number of calls possible by the MSL team per year was divided by the number of times an MSL member should meet with an MTL, for example, 6 meeting per year, that equates to interaction with 83 MTLs.

Based on this information combined with the results of the systems discussed below (i.e. MTL targeting system, CRM, statistical analysis and survey), at certain intervals of time, for example, annually, the sponsor company may evaluate the MSL group to ascertain whether its desired objective have been obtained. If the objective has not been obtained, the time spent on the elements noted in the above example can be changed to produce a different outcome which is closer to or meets the initial sponsor company objective based on analysis in the evaluation phase.

Establishing and Implementing Business Outcomes

In the system of the present invention, the desired business outcomes are defined by their attributes. Business outcomes are defined so that they are objective, measurable, and obvious to stakeholders when achieved. The business outcomes are typically chosen to reflect the activities of the customer physicians that the MSL group is able to influence. Typical MTL activities include, for example, publishing medical articles, conducting clinical investigations, attending formulary meetings, and lecturing. Generally, each defined business outcome is assigned a business outcome attribute also known as a Business Outcome Type. Examples of Business Outcome Types and a corresponding business outcome code are set forth in Table 2.

TABLE 2

| Business | |
|---|---|
| Outcome Code | Business Outcome Type |
| INVESTIGATOR | Investigator - MTL becomes a Sponsor |
| | investigator. |
| FORMULARY | Formulary Supporter - MTL advocates Sponsor |
| SUPPORTER | product at formulary meeting. |
| SPEAKER | Speaker - MTL speaks on Sponsor-selected |
| | topic. |
| CONSULTANT | Consultant - MTL serves as regional or |
| | national consultant. |
| AUTHOR | Author - MTL publishes article favorable to |
| | Sponsor product or disease management strategy. |
| PRESCRIBER | Prescriber - MTL prescribes Sponsor's product |
| | to a predetermined level (e.g., market share, |
| | prescription volume). |

The available Business Outcome Types are not limited to those listed in Table 2, but can be expanded or deleted as necessary to obtain a desired business objective.

Targeting Specific MTLs Using MTL Attributes The present invention includes a process for selecting and prioritizing MTLs according to a multiple attribute system that can assign specific weight to individual attributes to support the sponsor's customer management strategy to obtain a desired objective. The attributes measured are quantifiable and objective in nature. The MTL attributes can be categorized into measures of “voice” in the marketplace, i.e. publications, presentations, and relevant clinical investigation experience and measures of commercial potential/class prescription volume.

The attributes in the market place “voice” category are crucial for increasing product/brand awareness in the relevant medical communities and also reflect the degree of influence that an MTL exerts in these communities. These attributes can be used to prioritize MTLs along the dimension of influence on the practices of physicians in their sphere of influence. Such influence by MTLs has a major impact on acceptance and market uptake of pharmaceuticals. Commercial attributes, such as dollar volume of prescription writing, can be used to target MTLs who may have a direct business impact via their prescription writing for FDA approved indications. By assessing these attributes, MTLs are targeted in a manner that supports the sponsor company's business strategy. It is the responsibility of the MSL to develop business plans that outline major goals set for quarterly or annual evaluation, for example, the number of MTL journal publications, presentations, clinical investigations and number in prescription written.

Below is an example of an MTL prioritization process in accordance with the present invention. In this framework, quantifiable MTL attributes representative of “market voice” and commercial importance are identified and assigned a value. The value is then normalized by converting it into an Individual Component Relative Ranking Index (ICRRI) by the following equation:

ICRRI=value/((highest value−lowest value)/10)

which will result in an ICRRI with a value between approximately 1 and 10. Each attribute is evaluated based on the same equation:

Publications=Value/(highest value−lowest value)/10=ICRRI

Presentations=Value/(highest value−lowest value)/10=ICRRI

Investigations=Value/(highest value−lowest value)/10=ICRRI

Commercial Measure/Prescriptions=Value/(highest value−lowest value)/10=ICRRI

For example, the relative ranking index for publications may be calculated as follows:

Publications Relative Ranking Index=number of publications/((most publications by any MTL in the group−lowest number of publications by any MTL in the group)/10)

### EXAMPLE 3

### Using 10 Publications

$$\begin{matrix}Publication Relative Ranking Index = 10 / ( ( 50 - 2 ) / 10 ) \\ = 2.083\end{matrix}$$

### EXAMPLE 4

### Using 20 Publications

$$\begin{matrix}Publication Relative Ranking Index = 20 / ( ( 50 - 2 ) / 10 ) \\ = 4.17\end{matrix}$$

This same approach for calculating an ICRRI for the other MTL attributes such as Presentations, Investigations, and Commercial Measure.

### EXAMPLE 5

### ICRRI for Evaluation of MTL During Different Stages of Product Development and Market Life

Upon obtaining the index for each attribute as described above during the FDA approval process, e.g.,

Publication RRI=2.083

Presentation RRI=2.791

Investigations RRI=2.622

Commercial RRI=0 (note: since drug not approved, no prescriptions could be written)

The final MTL Relative Ranking Index is obtained by multiplying each ICRRI by a weighting value (making sure all weights sum to 1; e.g., 0.2, 0.4, 0.3, 0.1) and then sum the weight-adjusted component indices for the prioritization. The assignment of the weighting value corresponds to the importance of a particular attribute at a particular time.

| MTL Attribute | weighted component = 1.0 | value |
|---|---|---|
| Publication RRI = | 2.083 × 0.4 = | 0.83 |
| Presentation RRI = | 2.791 × 0.5 = | 1.40 |
| Investigations RRI = | 2.622 × 0.1 = | 0.26 |
| Commercial RRI = | 0.0 × 0.0 = | 0.0 |

This would then be evaluated by the sponsor company's goals as discussed above. Here, the amount of presentation would be found as the most prevalent attribute of the MTL targeted and should correspond to the goals set by the sponsor company at the particular time for a particular product.

However, the weighting of the index allows for changing the weights based on product lifecycle stage, without having to do major recalculations i.e., commercial can be weighted as zero during product development, or can be weighted heavily i.e., 0.8 for late phases in the product lifecycle. For example using the number achieved above but making evaluating 1 year after FDA approval:

$$\begin{matrix}\underline{MTL Attribute} & \underline{weighted component = 1.0} & \underline{value} \\ Publication RRI & = 2.083 \times 0.1 & = 0.2 \\ Presentation RRI & = 2.791 \times 0.1 & = 0.2 \\ Investigations RRI & = 2.622 \times 0.0 & = 0.0 \\ Commercial RRI & = 20.0 \times 0.8 & = 16.0\end{matrix}$$

If the highest ranking attribute coincides with the goal set by the sponsor company, the MSL has succeeded in obtaining the required objective. At a time of one year after FDA approval as illustrated above, the most predominate attribute may be commercial productivity, i.e. prescription writing, having a value of 16. This value should coincide with the objective of the sponsor company at one year after FDA approval.

Using sample data, Table 3 illustrates how a group of potential MTLs may be prioritized by ranking them according to the ICRRI. The attributes shown in this illustration are publications, presentations, clinical investigations, and commercial value of the individual prescription writing.

TABLE 3
Illustration of Prioritization of MTLs Using MTL Attributes

| | | | | Total | | | | | |
|---|---|---|---|---|---|---|---|---|---|
| | | Neoplasms | MM | Onc | ASCO | ASH Oral | ESMO | Total | Clinical |
| Last Name | First Name | Pubs | Pubs | Pubs | Presents | Presents | Presents | Presents | Investgtns |
| Barlogie | Bart | 264 | 35 | 299 | 17 | 9 | 5 | 31 | 35 |
| Alexanian | Raymond | 145 | 9 | 154 | 15 | 6 | 6 | 27 | 25 |
| Berenson | James | 85 | 24 | 109 | 13 | 8 | 7 | 28 | 19 |
| Blade | Joan | 96 | 16 | 112 | 18 | 6 | 5 | 29 | 16 |
| Ahmed | Tausee | 97 | 1 | 98 | 9 | 4 | 5 | 18 | 20 |
| Anderson | Kenneth | 89 | 42 | 131 | 7 | 2 | 6 | 15 | 17 |
| Attal | Michel | 19 | 10 | 29 | 4 | 1 | 4 | 9 | 13 |
| Akhtar | N | 5 | 2 | 7 | 4 | 3 | 4 | 11 | 7 |
| Alsina | Melissa | 36 | 5 | 41 | 8 | 2 | 2 | 12 | 6 |
| Bensinger | William | 9 | 3 | 12 | 8 | 3 | 5 | 16 | 4 |
| Besa | Emmanuel | 3 | 1 | 4 | 5 | 3 | 3 | 11 | 3 |
| Barrett | A | 7 | 2 | 9 | 3 | 1 | 7 | 11 | 3 |
| Agha | M | 3 | 1 | 4 | 5 | 1 | 2 | 8 | 4 |

| | Commercial | Pubs | Presents | Investigtns | Commercial | |
|---|---|---|---|---|---|---|
| | Value ($ | Ranking | Ranking | Ranking | Ranking | Prioritization |
| Last Name | MM scripts) | Variable | Variable | Variable | Variable | Index Value |
| Barlogie | $2,789,369 | 10.136 | 13.478 | 10.938 | 7.158 | 11.161 |
| Alexanian | $3,819,765 | 5.220 | 11.739 | 7.813 | 9.802 | 8.671 |
| Berenson | $3,896,778 | 3.695 | 12.174 | 5.938 | 10.000 | 7.766 |
| Blade | $1,907,222 | 3.797 | 12.609 | 5.000 | 4.894 | 7.031 |
| Ahmed | $2,689,996 | 3.322 | 7.826 | 6.250 | 6.903 | 6.203 |
| Anderson | $2,893,565 | 4.441 | 6.522 | 5.313 | 7.426 | 5.712 |
| Attal | $798,007 | 0.983 | 3.913 | 4.063 | 2.048 | 3.200 |
| Akhtar | $3,002,298 | 0.237 | 4.783 | 2.188 | 7.705 | 3.128 |
| Alsina | $978,232 | 1.390 | 5.217 | 1.875 | 2.510 | 2.844 |
| Bensinger | $478,563 | 0.407 | 6.957 | 1.250 | 1.228 | 2.791 |
| Besa | $298,786 | 0.136 | 4.783 | 0.938 | 0.767 | 1.914 |
| Barrett | $0 | 0.305 | 4.783 | 0.938 | 0.000 | 1.871 |
| Agha | $1,000,277 | 0.136 | 3.478 | 1.250 | 2.567 | 1.827 |

Individual Component Relative
Weighting:
Publications 0.2
Presentations 0.3
Investigations 0.4
Commercial 0.1

The results obtained by the attribute system may serve as part of the basis for the planning stage of a second cycle in obtaining another business objective defined by the sponsor company. The results of the components in the Evaluation Phase and in the CRM discussed below will also serve as the basis.

Customer Relation Management System (CRM)

The system of the present invention requires that customer interactions be documented and that certain attributes regarding the nature, duration, costs and date of each interaction be captured for retrospective analysis. A mechanism for tracking MSL activities and their impact is incorporated into a Customer Relation Management System (CRM). MSL-specific activity attributes may be incorporated into an existing CRM (using commercially available software with modifications) for the purposes of providing the data for analyses. The CRM allows for the assignment of specific business outcomes (see types and definitions above) to specifically targeted MTLs and preferably will define an end point when an outcome is achieved. Each customer interaction is documented in the CRM and is classified according to an activity type (see types and their definitions below). The CRM is capable of providing queries by MSL, MTL, Business Outcome Type, and Activity Type etc.

The present invention allows the information to be evaluated in order to provide for more efficient use of the time of interaction between the MSL and the MTL. This is based on the Customer Relation Management System (described below) which memorializes the interactions between the MSL and the MTL.

The data obtained from CRM is available for periodic reporting of activities and outcome achievement. As illustrated in Table 4, the periodic reporting format may be in the form of a “Scorecard”. The Scorecard consists of territory, regional, and national level data (the resolution to be defined by the Sponsor's MSL organizational structure). Information that may be included is the number of activities by type and by duration, funds spent/track to plan, time utilization, and position vacancies. These categories are not limiting and may be modified as needed to meet the predefined business objectives.

TABLE 4
CRM Data for MSL Dr. John Know by MTL
for Targeted Investigator Outcome

| | | | | | Targeted | Outcome |
|---|---|---|---|---|---|---|
| Interaction | MTL Last | MTL First | Activity | Duration of | Business | Achieved |
| Date | Name | Name | Type | Interaction | Outcome | (Y/N)? |
| Jan. 5, 2002 | Adams | Joan | REL | 30 | Investigator | N |
| Feb. 7, 2002 | Adams | Joan | KX | 25 | Investigator | N |
| Mar. 8, 2002 | Adams | Joan | KX | 10 | Investigator | N |
| Apr. 2, 2002 | Adams | Joan | ASSESS | 40 | Investigator | N |
| May 10, 2002 | Adams | Joan | RECRUIT | 60 | Investigator | N |
| Jun. 3, 2002 | Adams | Joan | REL | 120 | Investigator | Y |
| Jul. 9, 2002 | Adams | Joan | KX | 50 | Investigator | Y |
| Aug. 2, 2002 | Adams | Joan | KX | 40 | Investigator | Y |
| Aug. 28, 2002 | Adams | Joan | NET | 45 | Investigator | Y |
| Jan. 5, 2002 | Aden | A | REL | 40 | Investigator | N |
| Feb. 14, 2002 | Aden | A | ASSESS | 60 | Investigator | N |
| Mar. 19, 2002 | Aden | A | RECRUIT | 120 | Investigator | N |
| May 18, 2002 | Aden | A | RECRUIT | 50 | Investigator | N |
| Jun. 24, 2002 | Aden | A | REL | 20 | Investigator | N |
| Aug. 2, 2002 | Aden | A | KX | 40 | Investigator | Y |
| Jan. 5, 2002 | Benek | James | REL | 120 | Investigator | N |
| Feb. 7, 2002 | Benek | James | ASSESS | 50 | Investigator | N |
| Mar. 8, 2002 | Benek | James | KX | 20 | Investigator | N |
| Apr. 2, 2002 | Benek | James | RECRUIT | 40 | Investigator | N |
| May 10, 2002 | Benek | James | RECRUIT | 60 | Investigator | N |
| Jun. 3, 2002 | Benek | James | KX | 30 | Investigator | N |
| Jul. 9, 2002 | Benek | James | REL | 25 | Investigator | N |
| Aug. 2, 2002 | Benek | James | KX | 10 | Investigator | N |
| Aug. 28, 2002 | Benek | James | REL | 40 | Investigator | N |
| Jan. 5, 2002 | Casey | N | REL | 10 | Investigator | N |
| Feb. 7, 2002 | Casey | N | KX | 40 | Investigator | N |
| Mar. 9, 2002 | Casey | N | ASSESS | 60 | Investigator | N |
| Apr. 2, 2002 | Casey | N | RECRUIT | 120 | Investigator | N |
| May 15, 2002 | Casey | N | RECRUIT | 50 | Investigator | N |
| Jun. 24, 2002 | Casey | N | REL | 20 | Investigator | N |
| Jul. 20, 2002 | Casey | N | RECRUIT | 40 | Investigator | N |
| Aug. 2, 2002 | Casey | N | KX | 60 | Investigator | N |
| Aug. 28, 2002 | Casey | N | REL | 30 | Investigator | N |
| Jan. 5, 2002 | Dodds | Kenneth | REL | 50 | Investigator | N |
| Feb. 7, 2002 | Dodds | Kenneth | ASSESS | 20 | Investigator | N |
| Mar. 8, 2002 | Dodds | Kenneth | RECRUIT | 40 | Investigator | N |
| Apr. 2, 2002 | Dodds | Kenneth | REL | 60 | Investigator | N |
| May 15, 2002 | Dodds | Kenneth | KX | 30 | Investigator | N |
| Jun. 24, 2002 | Dodds | Kenneth | KX | 25 | Investigator | N |
| Jul. 20, 2002 | Dodds | Kenneth | KX | 10 | Investigator | N |
| Aug. 2, 2002 | Dodds | Kenneth | KX | 40 | Investigator | Y |
| Aug. 28, 2002 | Dodds | Kenneth | REL | 60 | Investigator | Y |
| Jan. 4, 2002 | Emrick | Michel | REL | 120 | Investigator | N |
| Feb. 7, 2002 | Emrick | Michel | ASSESS | 50 | Investigator | N |
| Mar. 9, 2002 | Emrick | Michel | RECRUIT | 20 | Investigator | N |
| Apr. 2, 2002 | Emrick | Michel | RECRUIT | 40 | Investigator | N |
| May 15, 2002 | Emrick | Michel | REL | 60 | Investigator | N |
| Jun. 24, 2002 | Emrick | Michel | REL | 30 | Investigator | N |
| Jul. 20, 2002 | Emrick | Michel | RECRUIT | 25 | Investigator | N |
| Aug. 2, 2002 | Emrick | Michel | KX | 10 | Investigator | N |
| Aug. 28, 2002 | Emrick | Michel | RECRUIT | 40 | Investigator | N |
| Jan. 4, 2002 | Fitch | Raymond | REL | 25 | Investigator | N |
| Feb. 7, 2002 | Fitch | Raymond | KX | 10 | Investigator | N |
| Mar. 8, 2002 | Fitch | Raymond | ASSESS | 40 | Investigator | N |
| Apr. 2, 2002 | Fitch | Raymond | RECRUIT | 60 | Investigator | N |
| May 10, 2002 | Fitch | Raymond | REL | 120 | Investigator | N |
| Jun. 3, 2002 | Fitch | Raymond | NET | 50 | Investigator | N |
| Jul. 9, 2002 | Fitch | Raymond | REL | 20 | Investigator | Y |
| Jul. 20, 2002 | Fitch | Raymond | KX | 40 | Investigator | Y |
| Aug. 28, 2002 | Fitch | Raymond | KX | 60 | Investigator | Y |
| Jan. 5, 2002 | Gerber | M | REL | 20 | Investigator | N |
| Feb. 14, 2002 | Gerber | M | KX | 40 | Investigator | N |
| Mar. 19, 2002 | Gerber | M | ASSESS | 60 | Investigator | N |
| May 18, 2002 | Gerber | M | NET | 30 | Investigator | N |
| Jun. 24, 2002 | Gerber | M | RECRUIT | 25 | Investigator | Y |
| Aug. 2, 2002 | Gerber | M | REL | 10 | Investigator | Y |
| Jan. 5, 2002 | Hicks | Melissa | REL | 30 | Investigator | N |
| Mar. 19, 2002 | Hicks | Melissa | ASSESS | 25 | Investigator | N |
| May 18, 2002 | Hicks | Melissa | RECRUIT | 10 | Investigator | N |
| Jun. 24, 2002 | Hicks | Melissa | KX | 40 | Investigator | Y |
| Aug. 2, 2002 | Hicks | Melissa | BUSSOL | 60 | Investigator | Y |
| Aug. 28, 2002 | Hicks | Melissa | KX | 120 | Investigator | Y |
| Jan. 4, 2002 | Howe | Tausee | REL | 40 | Investigator | N |
| Feb. 7, 2002 | Howe | Tausee | REL | 60 | Investigator | N |
| Mar. 8, 2002 | Howe | Tausee | ASSESS | 120 | Investigator | N |
| Apr. 2, 2002 | Howe | Tausee | KX | 50 | Investigator | N |
| May 10, 2002 | Howe | Tausee | KX | 20 | Investigator | N |
| Jun. 8, 2002 | Howe | Tausee | RECRUIT | 40 | Investigator | N |
| Jul. 9, 2002 | Howe | Tausee | NET | 60 | Investigator | N |
| Aug. 2, 2002 | Howe | Tausee | MEDSOL | 30 | Investigator | Y |
| Aug. 28, 2002 | Howe | Tausee | REL | 25 | Investigator | Y |
| Jan. 4, 2002 | Keeler | Bart | REL | 60 | Investigator | N |
| Feb. 7, 2002 | Keeler | Bart | ASSESS | 120 | Investigator | N |
| Mar. 8, 2002 | Keeler | Bart | RECRUIT | 50 | Investigator | N |
| Apr. 2, 2002 | Keeler | Bart | KX | 20 | Investigator | N |
| May 10, 2002 | Keeler | Bart | REL | 40 | Investigator | N |
| Jun. 3, 2002 | Keeler | Bart | COACH | 60 | Investigator | N |
| Jul. 9, 2002 | Keeler | Bart | BUSSOL | 30 | Investigator | N |
| Jul. 20, 2002 | Keeler | Bart | REL | 25 | Investigator | Y |
| Aug. 28, 2002 | Keeler | Bart | REL | 10 | Investigator | Y |
| Jan. 4, 2002 | Lucas | Emmanuel | REL | 60 | Investigator | N |
| Feb. 14, 2002 | Lucas | Emmanuel | KX | 120 | Investigator | N |
| Mar. 19, 2002 | Lucas | Emmanuel | ASSESS | 50 | Investigator | N |
| May 18, 2002 | Lucas | Emmanuel | RECRUIT | 20 | Investigator | N |
| Jun. 24, 2002 | Lucas | Emmanuel | REL | 40 | Investigator | N |
| Aug. 2, 2002 | Lucas | Emmanuel | REL | 60 | Investigator | N |
| Jan. 4, 2002 | Markley | William | REL | 60 | Investigator | N |
| Feb. 14, 2002 | Markley | William | RECRUIT | 30 | Investigator | N |
| Mar. 19, 2002 | Markley | William | RECRUIT | 25 | Investigator | N |
| May 18, 2002 | Markley | William | KX | 10 | Investigator | N |
| Jun. 24, 2002 | Markley | William | REL | 40 | Investigator | N |
| Aug. 2, 2002 | Markley | William | REL | 60 | Investigator | N |
| Jan. 5, 2002 | Martin | Joan | REL | 30 | Investigator | N |
| Feb. 7, 2002 | Martin | Joan | KX | 25 | Investigator | N |
| Mar. 8, 2002 | Martin | Joan | MEDSOL | 10 | Investigator | N |
| Apr. 2, 2002 | Martin | Joan | ASSESS | 40 | Investigator | N |
| May 10, 2002 | Martin | Joan | RECRUIT | 60 | Investigator | N |
| Jun. 3, 2002 | Martin | Joan | REL | 120 | Investigator | Y |
| Jul. 9, 2002 | Martin | Joan | KX | 50 | Investigator | Y |
| Aug. 2, 2002 | Martin | Joan | KX | 40 | Investigator | Y |
| Aug. 28, 2002 | Martin | Joan | NET | 45 | Investigator | Y |
| Jan. 5, 2002 | Metzger | A | REL | 40 | Investigator | N |
| Feb. 14, 2002 | Metzger | A | KX | 60 | Investigator | N |
| Mar. 19, 2002 | Metzger | A | ASSESS | 120 | Investigator | N |
| May 18, 2002 | Metzger | A | RECRUIT | 50 | Investigator | N |
| Jun. 24, 2002 | Metzger | A | BUSSOL | 20 | Investigator | N |
| Aug. 2, 2002 | Metzger | A | KX | 40 | Investigator | Y |
| Jan. 5, 2002 | Milnes | James | REL | 120 | Investigator | N |
| Feb. 7, 2002 | Milnes | James | REL | 50 | Investigator | N |
| Mar. 8, 2002 | Milnes | James | ASSESS | 20 | Investigator | N |
| Apr. 2, 2002 | Milnes | James | RECRUIT | 40 | Investigator | N |
| May 10, 2002 | Milnes | James | RECRUIT | 60 | Investigator | N |
| Jun. 3, 2002 | Milnes | James | KX | 30 | Investigator | N |
| Jul. 9, 2002 | Milnes | James | REL | 25 | Investigator | N |
| Aug. 2, 2002 | Milnes | James | KX | 10 | Investigator | N |
| Aug. 28, 2002 | Milnes | James | REL | 40 | Investigator | N |
| Jan. 5, 2002 | Myers | N | REL | 10 | Investigator | N |
| Feb. 7, 2002 | Myers | N | KX | 40 | Investigator | N |
| Mar. 9, 2002 | Myers | N | ASSESS | 60 | Investigator | N |
| Apr. 2, 2002 | Myers | N | RECRUIT | 120 | Investigator | N |
| May 15, 2002 | Myers | N | RECRUIT | 50 | Investigator | N |
| Jun. 24, 2002 | Myers | N | REL | 20 | Investigator | N |
| Jul. 20, 2002 | Myers | N | RECRUIT | 40 | Investigator | N |
| Aug. 2, 2002 | Myers | N | KX | 60 | Investigator | N |
| Aug. 28, 2002 | Myers | N | REL | 30 | Investigator | N |
| Jan. 5, 2002 | Nichols | Kenneth | REL | 50 | Investigator | N |
| Feb. 7, 2002 | Nichols | Kenneth | ASSESS | 20 | Investigator | N |
| Mar. 8, 2002 | Nichols | Kenneth | RECRUIT | 40 | Investigator | N |
| Apr. 2, 2002 | Nichols | Kenneth | REL | 60 | Investigator | N |
| May 15, 2002 | Nichols | Kenneth | KX | 30 | Investigator | N |
| Jun. 24, 2002 | Nichols | Kenneth | KX | 25 | Investigator | N |
| Jul. 20, 2002 | Nichols | Kenneth | KX | 10 | Investigator | N |
| Aug. 2, 2002 | Nichols | Kenneth | KX | 40 | Investigator | Y |
| Aug. 28, 2002 | Nichols | Kenneth | REL | 60 | Investigator | Y |
| Jan. 4, 2002 | Nolan | Michel | REL | 120 | Investigator | N |
| Feb. 7, 2002 | Nolan | Michel | KX | 50 | Investigator | N |
| Mar. 9, 2002 | Nolan | Michel | ASSESS | 20 | Investigator | N |
| Apr. 2, 2002 | Nolan | Michel | RECRUIT | 40 | Investigator | N |
| May 15, 2002 | Nolan | Michel | REL | 60 | Investigator | N |
| Jun. 24, 2002 | Nolan | Michel | REL | 30 | Investigator | N |
| Jul. 20, 2002 | Nolan | Michel | RECRUIT | 25 | Investigator | N |
| Aug. 2, 2002 | Nolan | Michel | KX | 10 | Investigator | N |
| Aug. 28, 2002 | Nolan | Michel | RECRUIT | 40 | Investigator | N |
| Jan. 4, 2002 | Osborne | Raymond | REL | 25 | Investigator | N |
| Feb. 7, 2002 | Osborne | Raymond | ASSESS | 10 | Investigator | N |
| Mar. 8, 2002 | Osborne | Raymond | RECRUIT | 40 | Investigator | N |
| Apr. 2, 2002 | Osborne | Raymond | KX | 60 | Investigator | N |
| May 10, 2002 | Osborne | Raymond | REL | 120 | Investigator | N |
| Jun. 3, 2002 | Osborne | Raymond | NET | 50 | Investigator | N |
| Jul. 9, 2002 | Osborne | Raymond | REL | 20 | Investigator | Y |
| Jul. 20, 2002 | Osborne | Raymond | KX | 40 | Investigator | Y |
| Aug. 28, 2002 | Osborne | Raymond | KX | 60 | Investigator | Y |
| Jan. 5, 2002 | Owens | M | REL | 20 | Investigator | N |
| Feb. 14, 2002 | Owens | M | KX | 40 | Investigator | N |
| Mar. 19, 2002 | Owens | M | REL | 60 | Investigator | N |
| May 18, 2002 | Owens | M | NET | 30 | Investigator | N |
| Jun. 24, 2002 | Owens | M | REL | 25 | Investigator | N |
| Aug. 2, 2002 | Owens | M | REL | 10 | Investigator | N |
| Jan. 5, 2002 | Padva | Melissa | REL | 30 | Investigator | N |
| Mar. 19, 2002 | Padva | Melissa | REL | 25 | Investigator | N |
| May 18, 2002 | Padva | Melissa | REL | 10 | Investigator | N |
| Jun. 24, 2002 | Padva | Melissa | KX | 40 | Investigator | N |
| Aug. 2, 2002 | Padva | Melissa | KX | 60 | Investigator | N |
| Aug. 28, 2002 | Padva | Melissa | KX | 120 | Investigator | N |
| Jan. 4, 2002 | Patterson | Tausee | REL | 40 | Investigator | N |
| Feb. 7, 2002 | Patterson | Tausee | REL | 60 | Investigator | N |
| Mar. 8, 2002 | Patterson | Tausee | KX | 120 | Investigator | N |
| Apr. 2, 2002 | Patterson | Tausee | ASSESS | 50 | Investigator | N |
| May 10, 2002 | Patterson | Tausee | RECRUIT | 20 | Investigator | N |
| Jun. 8, 2002 | Patterson | Tausee | REL | 40 | Investigator | N |
| Jul. 9, 2002 | Patterson | Tausee | NET | 60 | Investigator | N |
| Aug. 2, 2002 | Patterson | Tausee | MEDSOL | 30 | Investigator | Y |
| Aug. 28, 2002 | Patterson | Tausee | REL | 25 | Investigator | Y |
| Jan. 4, 2002 | Petty | Bart | REL | 60 | Investigator | N |
| Feb. 7, 2002 | Petty | Bart | ASSESS | 120 | Investigator | N |
| Mar. 8, 2002 | Petty | Bart | RECRUIT | 50 | Investigator | N |
| Apr. 2, 2002 | Petty | Bart | KX | 20 | Investigator | N |
| May 10, 2002 | Petty | Bart | REL | 40 | Investigator | N |
| Jun. 3, 2002 | Petty | Bart | COACH | 60 | Investigator | N |
| Jul. 9, 2002 | Petty | Bart | KX | 30 | Investigator | N |
| Jul. 20, 2002 | Petty | Bart | REL | 25 | Investigator | Y |
| Aug. 28, 2002 | Petty | Bart | REL | 10 | Investigator | Y |
| Jan. 4, 2002 | Philbin | Emmanuel | REL | 60 | Investigator | N |
| Feb. 14, 2002 | Philbin | Emmanuel | KX | 120 | Investigator | N |
| Mar. 19, 2002 | Philbin | Emmanuel | RECRUIT | 50 | Investigator | N |
| May 18, 2002 | Philbin | Emmanuel | RECRUIT | 20 | Investigator | N |
| Jun. 24, 2002 | Philbin | Emmanuel | REL | 40 | Investigator | N |
| Aug. 2, 2002 | Philbin | Emmanuel | REL | 60 | Investigator | N |
| Jan. 4, 2002 | Pollack | William | REL | 60 | Investigator | N |
| Feb. 14, 2002 | Pollack | William | RECRUIT | 30 | Investigator | N |
| Mar. 19, 2002 | Pollack | William | RECRUIT | 25 | Investigator | N |
| May 18, 2002 | Pollack | William | KX | 10 | Investigator | N |
| Jun. 24, 2002 | Pollack | William | REL | 40 | Investigator | N |
| Aug. 2, 2002 | Pollack | William | REL | 60 | Investigator | N |
| Jan. 5, 2002 | Potter | Joan | REL | 30 | Investigator | N |
| Feb. 7, 2002 | Potter | Joan | KX | 25 | Investigator | N |
| Mar. 8, 2002 | Potter | Joan | KX | 10 | Investigator | N |
| Apr. 2, 2002 | Potter | Joan | ASSESS | 40 | Investigator | N |
| May 10, 2002 | Potter | Joan | RECRUIT | 60 | Investigator | N |
| Jun. 3, 2002 | Potter | Joan | REL | 120 | Investigator | Y |
| Jul. 9, 2002 | Potter | Joan | KX | 50 | Investigator | Y |
| Aug. 2, 2002 | Potter | Joan | KX | 40 | Investigator | Y |
| Aug. 28, 2002 | Potter | Joan | NET | 45 | Investigator | Y |
| Jan. 5, 2002 | Ramsey | A | REL | 40 | Investigator | N |
| Feb. 14, 2002 | Ramsey | A | KX | 60 | Investigator | N |
| Mar. 19, 2002 | Ramsey | A | RECRUIT | 120 | Investigator | N |
| May 18, 2002 | Ramsey | A | RECRUIT | 50 | Investigator | N |
| Jun. 24, 2002 | Ramsey | A | REL | 20 | Investigator | N |
| Aug. 2, 2002 | Ramsey | A | KX | 40 | Investigator | N |
| Jan. 5, 2002 | Reinhart | James | REL | 120 | Investigator | N |
| Feb. 7, 2002 | Reinhart | James | REL | 50 | Investigator | N |
| Mar. 8, 2002 | Reinhart | James | KX | 20 | Investigator | N |
| Apr. 2, 2002 | Reinhart | James | RECRUIT | 40 | Investigator | N |
| May 10, 2002 | Reinhart | James | RECRUIT | 60 | Investigator | N |
| Jun. 3, 2002 | Reinhart | James | KX | 30 | Investigator | N |
| Jul. 9, 2002 | Reinhart | James | REL | 25 | Investigator | N |
| Aug. 2, 2002 | Reinhart | James | KX | 10 | Investigator | N |
| Aug. 28, 2002 | Reinhart | James | REL | 40 | Investigator | N |
| Jan. 5, 2002 | Richards | N | REL | 10 | Investigator | N |
| Feb. 7, 2002 | Richards | N | KX | 40 | Investigator | N |
| Mar. 9, 2002 | Richards | N | REL | 60 | Investigator | N |
| Apr. 2, 2002 | Richards | N | RECRUIT | 120 | Investigator | N |
| May 15, 2002 | Richards | N | RECRUIT | 50 | Investigator | N |
| Jun. 24, 2002 | Richards | N | REL | 20 | Investigator | N |
| Jul. 20, 2002 | Richards | N | RECRUIT | 40 | Investigator | N |
| Aug. 2, 2002 | Richards | N | KX | 60 | Investigator | N |
| Aug. 28, 2002 | Richards | N | REL | 30 | Investigator | N |
| Jan. 5, 2002 | Rosen | Kenneth | REL | 50 | Investigator | N |
| Feb. 7, 2002 | Rosen | Kenneth | ASSESS | 20 | Investigator | N |
| Mar. 8, 2002 | Rosen | Kenneth | RECRUIT | 40 | Investigator | N |
| Apr. 2, 2002 | Rosen | Kenneth | REL | 60 | Investigator | N |
| May 15, 2002 | Rosen | Kenneth | KX | 30 | Investigator | N |
| Jun. 24, 2002 | Rosen | Kenneth | KX | 25 | Investigator | N |
| Jul. 20, 2002 | Rosen | Kenneth | KX | 10 | Investigator | N |
| Aug. 2, 2002 | Rosen | Kenneth | KX | 40 | Investigator | Y |
| Aug. 28, 2002 | Rosen | Kenneth | REL | 60 | Investigator | Y |
| Jan. 4, 2002 | Ryan | Michel | REL | 120 | Investigator | N |
| Feb. 7, 2002 | Ryan | Michel | KX | 50 | Investigator | N |
| Mar. 9, 2002 | Ryan | Michel | RECRUIT | 20 | Investigator | N |
| Apr. 2, 2002 | Ryan | Michel | RECRUIT | 40 | Investigator | N |
| May 15, 2002 | Ryan | Michel | REL | 60 | Investigator | N |
| Jun. 24, 2002 | Ryan | Michel | REL | 30 | Investigator | N |
| Jul. 20, 2002 | Ryan | Michel | RECRUIT | 25 | Investigator | N |
| Aug. 2, 2002 | Ryan | Michel | KX | 10 | Investigator | N |
| Aug. 28, 2002 | Ryan | Michel | RECRUIT | 40 | Investigator | N |
| Jan. 4, 2002 | Saxton | Raymond | REL | 25 | Investigator | N |
| Feb. 7, 2002 | Saxton | Raymond | RECRUIT | 10 | Investigator | N |
| Mar. 8, 2002 | Saxton | Raymond | RECRUIT | 40 | Investigator | N |
| Apr. 2, 2002 | Saxton | Raymond | KX | 60 | Investigator | N |
| May 10, 2002 | Saxton | Raymond | REL | 120 | Investigator | N |
| Jun. 3, 2002 | Saxton | Raymond | NET | 50 | Investigator | N |
| Jul. 9, 2002 | Saxton | Raymond | REL | 20 | Investigator | N |
| Jul. 20, 2002 | Saxton | Raymond | KX | 40 | Investigator | N |
| Aug. 28, 2002 | Saxton | Raymond | KX | 60 | Investigator | N |
| Jan. 5, 2002 | Schmitt | M | REL | 20 | Investigator | N |
| Feb. 14, 2002 | Schmitt | M | KX | 40 | Investigator | N |
| Mar. 19, 2002 | Schmitt | M | RECRUIT | 60 | Investigator | N |
| May 18, 2002 | Schmitt | M | NET | 30 | Investigator | N |
| Jun. 24, 2002 | Schmitt | M | BUSSOL | 25 | Investigator | N |
| Aug. 2, 2002 | Schmitt | M | REL | 10 | Investigator | Y |
| Jan. 5, 2002 | Stewart | Melissa | REL | 30 | Investigator | N |
| Mar. 19, 2002 | Stewart | Melissa | REL | 25 | Investigator | N |
| May 18, 2002 | Stewart | Melissa | REL | 10 | Investigator | N |
| Jun. 24, 2002 | Stewart | Melissa | KX | 40 | Investigator | N |
| Aug. 2, 2002 | Stewart | Melissa | KX | 60 | Investigator | N |
| Aug. 28, 2002 | Stewart | Melissa | KX | 120 | Investigator | N |
| Jan. 4, 2002 | Thompson | Tausee | REL | 40 | Investigator | N |
| Feb. 7, 2002 | Thompson | Tausee | REL | 60 | Investigator | N |
| Mar. 8, 2002 | Thompson | Tausee | ASSESS | 120 | Investigator | N |
| Apr. 2, 2002 | Thompson | Tausee | KX | 50 | Investigator | N |
| May 10, 2002 | Thompson | Tausee | KX | 20 | Investigator | N |
| Jun. 8, 2002 | Thompson | Tausee | REL | 40 | Investigator | N |
| Jul. 9, 2002 | Thompson | Tausee | NET | 60 | Investigator | N |
| Aug. 2, 2002 | Thompson | Tausee | REL | 30 | Investigator | N |
| Aug. 28, 2002 | Thompson | Tausee | REL | 25 | Investigator | N |
| Jan. 4, 2002 | Ulshafer | Bart | REL | 60 | Investigator | N |
| Feb. 7, 2002 | Ulshafer | Bart | ASSESS | 120 | Investigator | N |
| Mar. 8, 2002 | Ulshafer | Bart | RECRUIT | 50 | Investigator | N |
| Apr. 2, 2002 | Ulshafer | Bart | KX | 20 | Investigator | N |
| May 10, 2002 | Ulshafer | Bart | REL | 40 | Investigator | N |
| Jun. 3, 2002 | Ulshafer | Bart | COACH | 60 | Investigator | N |
| Jul. 9, 2002 | Ulshafer | Bart | KX | 30 | Investigator | N |
| Jul. 20, 2002 | Ulshafer | Bart | REL | 25 | Investigator | Y |
| Aug. 28, 2002 | Ulshafer | Bart | REL | 10 | Investigator | Y |
| Jan. 4, 2002 | Vogel | Emmanuel | REL | 60 | Investigator | N |
| Feb. 14, 2002 | Vogel | Emmanuel | KX | 120 | Investigator | N |
| Mar. 19, 2002 | Vogel | Emmanuel | RECRUIT | 50 | Investigator | N |
| May 18, 2002 | Vogel | Emmanuel | RECRUIT | 20 | Investigator | N |
| Jun. 24, 2002 | Vogel | Emmanuel | REL | 40 | Investigator | N |
| Aug. 2, 2002 | Vogel | Emmanuel | REL | 60 | Investigator | N |
| Jan. 4, 2002 | Wellington | William | REL | 60 | Investigator | N |
| Feb. 14, 2002 | Wellington | William | RECRUIT | 30 | Investigator | N |
| Mar. 19, 2002 | Wellington | William | RECRUIT | 25 | Investigator | N |
| May 18, 2002 | Wellington | William | KX | 10 | Investigator | N |
| Jun. 24, 2002 | Wellington | William | REL | 40 | Investigator | N |
| Aug. 2, 2002 | Wellington | William | REL | 60 | Investigator | N |

Referring to Table 4, a scorecard is illustrated summarizing various types of activities and recorded information based on the interaction between the MSL representative, Dr. John Know and various MTLs over a predefined period of time. These particular activities were concentrated for the particular business outcome goal of investigator (as described above). This information is further summarized in Table 5, wherein the time spent is particularly broken down in order to be able to use the information based on whether the business outcome (investigator) had been achieved and what types of activities may need to be done, in terms of changing the activities when interacting with a particular MTL. Table 5 illustrates the activity data for each particular MSL in a certain period of time. This output allows (a) evaluation by management as to the daily activity of an MSL and (b) a journal for organization and planning of the MSL activity in the future.

TABLE 5
Frequency by Activity Type and Cumulative Duration by MTL

| | | | | | | | | | Total In- | | | | |
|---|---|---|---|---|---|---|---|---|---|---|---|---|---|
| | | | | | | | | | teractions | | | | |
| | | | | | | | | | Prior to | Average | Cumulative | Outcome | |
| | RE- | | | | AS- | | | | Achieving | Interaction | Interactions | Achieved | Business |
| MTL | CRUIT | COACH | REL | NET | SESS | BUSSOL | MEDSOL | KX | Outcome | Duration | Duration | (Y/N) | Outcome |
| Abptar | 3 | | 3 | | 1 | | | 2 | 9 | 47.8 | 430 | N | Investigator |
| Agha | 1 | | 2 | 1 | 1 | | | 1 | 6 | 35.0 | 210 | Y | Investigator |
| Ahmed | 1 | | 3 | 1 | 1 | | 1 | 2 | 9 | 52.8 | 475 | Y | Investigator |
| Akhtar | 3 | | 3 | | 1 | | | 2 | 9 | 47.8 | 430 | N | Investigator |
| Alexanian | 1 | | 3 | 1 | 1 | | | 3 | 9 | 49.4 | 445 | Y | Investigator |
| Alixandor | 1 | | 3 | 1 | 1 | | | 3 | 9 | 49.4 | 445 | Y | Investigator |
| Alsina | 1 | | 1 | | 1 | 1 | | 2 | 6 | 54.2 | 325 | Y | Investigator |
| Anderson | 1 | | 3 | | 1 | | | 4 | 9 | 41.7 | 375 | Y | Investigator |
| Andersten | 1 | | 3 | | 1 | | | 4 | 9 | 41.7 | 375 | Y | Investigator |
| Attal | 4 | | 3 | | 1 | | | 1 | 9 | 43.9 | 395 | N | Investigator |
| Baholst | 1 | | 1 | | 1 | 1 | | 2 | 6 | 61.7 | 370 | Y | Investigator |
| Barlogie | 1 | 1 | 4 | | 1 | 1 | | 1 | 9 | 48.9 | 440 | Y | Investigator |
| Barrett | 2 | | 2 | | 1 | | | 1 | 6 | 61.7 | 370 | Y | Investigator |
| Barsot | 1 | 1 | 4 | | 1 | | | 2 | 9 | 48.9 | 440 | Y | Investigator |
| Bensinger | 2 | | 3 | | | | | 1 | 6 | 37.5 | 225 | N | Investigator |
| Bensoner | 2 | | 4 | | 1 | | | 2 | 9 | 43.9 | 395 | N | Investigator |
| Bentinger | 2 | | 3 | | | | | 1 | 6 | 37.5 | 225 | N | Investigator |
| Berenson | 2 | | 3 | | 1 | | | 3 | 9 | 43.9 | 395 | N | Investigator |
| Besa | 1 | | 3 | | 1 | | | 1 | 6 | 58.3 | 350 | N | Investigator |
| Besalt | 2 | | 3 | | | | | 1 | 6 | 58.3 | 350 | N | Investigator |
| Blade | 1 | | 2 | 1 | 1 | | | 4 | 9 | 60.0 | 540 | Y | Investigator |
| Burnast | | | 4 | 1 | | | | 1 | 6 | 29.2 | 175 | N | Investigator |
| Cahmet | 1 | | 4 | 1 | 1 | | 1 | 1 | 9 | 52.8 | 475 | Y | Investigator |
| Calsina | | | 3 | | | | | 3 | 6 | 17.5 | 105 | N | Investigator |
| Codst | 3 | | 3 | | 1 | | | 2 | 9 | 43.9 | 395 | N | Investigator |
| Dickerson | 1 | | 2 | 1 | 1 | | 1 | 3 | 9 | 60.0 | 540 | Y | Investigator |
| Fabptar | 3 | | 4 | | | | | 2 | 9 | 47.8 | 430 | N | Investigator |
| Fahmet | | | 5 | 1 | 1 | | | 2 | 9 | 49.4 | 445 | N | Investigator |
| Falexan | 2 | | 3 | 1 | | | | 3 | 9 | 47.2 | 425 | N | Investigator |
| Falsina | | | 3 | | | | | 3 | 6 | 47.5 | 285 | N | Investigator |
| Feholst | 2 | | 2 | | | | | 2 | 6 | 55.0 | 330 | N | Investigator |
| Fendersten | 1 | | 3 | | 1 | | | 4 | 9 | 42.8 | 385 | Y | Investigator |
| Fensoner | 2 | | 4 | | | | | 3 | 9 | 43.9 | 395 | N | Investigator |
| Fersot | 1 | 1 | 4 | | 1 | | | 2 | 9 | 48.9 | 440 | Y | Investigator |
| Fickerson | 1 | | 2 | 1 | 1 | | | 4 | 9 | 60.0 | 540 | Y | Investigator |
| Fodsten | 4 | | 3 | | | | | 2 | 9 | 43.9 | 395 | N | Investigator |
| Funtinger | 2 | | 3 | | | | | 1 | 6 | 37.5 | 225 | N | Investigator |
| Furnast | 1 | | 2 | 1 | | 1 | | 1 | 6 | 30.8 | 185 | Y | Investigator |
| Fusalt | 2 | | 3 | | | | | 1 | 6 | 58.3 | 350 | N | Investigator |

Table 6 below illustrates yet another view of the exemplary data in which the frequency and duration of customer interaction are set forth by activity type for each MTL having a successful investigator outcome.

TABLE 6
Summary of Frequency and Duration by Activity Type
Resulting in Successful Investigation Outcome

| | |
|---|---|
| Outcome Achieved (Y/N)? | Y |

| Targeted | MTL | | | |
|---|---|---|---|---|
| Business | Last | Activity | | |
| Outcome | Name | Type | Data | Total |
| Inves- | Gerber | RECRUIT | Count of | 1 |
| tigator | | | Activity Type | |
| | | | Sum of Duration | 25 |
| | | | of Interaction | |
| | | REL | Count of | 1 |
| | | | Activity Type | |
| | | | Sum of Duration | 10 |
| | | | of Interaction | |
| | Gerber Count of Activity Type | | | 2 |
| | Gerber Sum of Duration of Interaction | | | 35 |
| | Howe | MEDSOL | Count of | 1 |
| | | | Activity Type | |
| | | | Sum of Duration | 30 |
| | | | of Interaction | |
| | | REL | Count of | 1 |
| | | | Activity Type | |
| | | | Sum of Duration | 25 |
| | | | of Interaction | |
| | Howe Count of Activity Type | | | 2 |
| | Howe Sum of Duration of Interaction | | | 55 |
| | Fitch | KX | Count of | 2 |
| | | | Activity Type | |
| | | | Sum of Duration | 100 |
| | | | of Interaction | |
| | | REL | Count of | 1 |
| | | | Activity Type | |
| | | | Sum of Duration | 20 |
| | | | of Interaction | |
| | Fitch Count ofActivity Type | | | 3 |
| | Fitch Sum of Duration of Interaction | | | 120 |
| | Osborne | KX | Count of | 2 |
| | | | Activity Type | |
| | | | Sum of Duration | 100 |
| | | | of Interaction | |
| | | REL | Count of | 1 |
| | | | Activity Type | |
| | | | Sum of Duration | 20 |
| | | | of Interaction | |
| | Osborne Count of Activity Type | | | 3 |
| | Osborne Sum of Duration of Interaction | | | 120 |
| | Hicks | BUSSOL | Count of | 1 |
| | | | Activity Type | |
| | | | Sum of Duration | 60 |
| | | | of Interaction | |
| | | KX | Count of | 2 |
| | | | Activity Type | |
| | | | Sum of Duration | 160 |
| | | | of Interaction | |
| | Hicks Count of Activity Type | | | 3 |
| | Hicks Sum of Duration of Interaction | | | 220 |
| | Dodds | KX | Count of | 1 |
| | | | Activity Type | |
| | | | Sum of Duration | 40 |
| | | | of Interaction | |
| | | REL | Count of | 1 |
| | | | Activity Type | |
| | | | Sum of Duration | 60 |
| | | | of Interaction | |
| | Dodds Count of Activity Type | | | 2 |
| | Dodds Sum of Duration of Interaction | | | 100 |
| | Nichols | KX | Count of | 1 |
| | | | Activity Type | |
| | | | Sum of Duration | 40 |
| | | | of Interaction | |
| | | REL | Count of | 1 |
| | | | Activity Type | |
| | | | Sum of Duration | 60 |
| | | | of Interaction | |
| | Nichols Count of Activity Type | | | 2 |
| | Nichols Sum of Duration of Interaction | | | 100 |
| | Metzger | KX | Count of | 1 |
| | | | Activity Type | |
| | | | Sum of Duration | 40 |
| | | | of Interaction | |
| | Metzger Count of Activity Type | | | 1 |
| | Metzger Sum of Duration of Interaction | | | 40 |
| | Keeler | REL | Count of | 2 |
| | | | Activity Type | |
| | | | Sum of Duration | 35 |
| | | | of Interaction | |
| | Keeler Count of Activity Type | | | 2 |
| | Keeler Sum of Duration of Interaction | | | 35 |
| | Aden | KX | Count of | 1 |
| | | | Activity Type | |
| | | | Sum of Duration | 40 |
| | | | of Interaction | |
| | Aden Count of Activity Type | | | 1 |
| | Aden Sum of Duration of Interaction | | | 40 |
| | Petty | REL | Count of | 2 |
| | | | Activity Type | |
| | | | Sum of Duration | 35 |
| | | | of Interaction | |
| | Petty Count of Activity Type | | | 2 |
| | Petty Sum of Duration of Interaction | | | 35 |
| | Adams | KX | Count of | 2 |
| | | | Activity Type | |
| | | | Sum of Duration | 90 |
| | | | of Interaction | |
| | | NET | Count of | 1 |
| | | | Activity Type | |
| | | | Sum of Duration | 45 |
| | | | of Interaction | |
| | | REL | Count of | 1 |
| | | | Activity Type | |
| | | | Sum of Duration | 120 |
| | | | of Interaction | |
| | Adams Count of Activity Type | | | 4 |
| | Adams Sum of Duration of Interaction | | | 255 |
| | Patterson | MEDSOL | Count of | 1 |
| | | | Activity Type | |
| | | | Sum of Duration | 30 |
| | | | of Interaction | |
| | | REL | Count of | 1 |
| | | | Activity Type | |
| | | | Sum of Duration | 25 |
| | | | of Interaction | |
| | Patterson Count of Activity Type | | | 2 |
| | Patterson Sum of Duration of Interaction | | | 55 |
| | Martin | KX | Count of | 2 |
| | | | Activity Type | |
| | | | Sum of Duration | 90 |
| | | | of Interaction | |
| | | NET | Count of | 1 |
| | | | Activity Type | |
| | | | Sum of Duration | 45 |
| | | | of Interaction | |
| | | REL | Count of | 1 |
| | | | Activity Type | |
| | | | Sum of Duration | 120 |
| | | | of Interaction | |
| | Martin Count of Activity Type | | | 4 |
| | Martin Sum of Duration of Interaction | | | 255 |
| | Rosen | KX | Count of | 1 |
| | | | Activity Type | |
| | | | Sum of Duration | 40 |
| | | | of Interaction | |
| | | REL | Count of | 1 |
| | | | Activity Type | |
| | | | Sum of Duration | 60 |
| | | | of Interaction | |
| | Rosen Count of Activity Type | | | 2 |
| | Rosen Sum of Duration of Interaction | | | 100 |
| | Ulshafer | REL | Count of | 2 |
| | | | Activity Type | |
| | | | Sum of Duration | 35 |
| | | | of Interaction | |
| | Ulshafer Count of Activity Type | | | 2 |
| | Ulshafer Sum of Duration of Interaction | | | 35 |
| | Potter | KX | Count of | 2 |
| | | | Activity Type | |
| | | | Sum of Duration | 90 |
| | | | of Interaction | |
| | | NET | Count of | 1 |
| | | | Activity Type | |
| | | | Sum of Duration | 45 |
| | | | of Interaction | |
| | | REL | Count of | 1 |
| | | | Activity Type | |
| | | | Sum of Duration | 120 |
| | | | of Interaction | |
| | Potter Count of Activity Type | | | 4 |
| | Potter Sum of Duration of Interaction | | | 255 |
| | Schmitt | REL | Count of | 1 |
| | | | Activity Type | |
| | | | Sum of Duration | 10 |
| | | | of Interaction | |

| | |
|---|---|
| Schmitt Count of Activity Type | 1 |
| Schmitt Sum of Duration of Interaction | 10 |

| | |
|---|---|
| Investigator Count of Activity Type | 42 |
| Investigator Sum of Duration of Interaction | 1865 |
| Total Count of Activity Type | 42 |
| Total Sum of Duration of Interaction | 1865 |

The data incorporated into the CRM are particularly useful for prompt, accurate and specific “activity to outcome” analysis. For example, the interactions with MTL Adams yielded a desired outcome of investigator based on the activities and time as highlighted in FIG. 2. In contrast, the desired outcome of investigator was not achieved by the activities and time spent on MTL Philbin.

Evaluating Phase

The Evaluating phase examines metrics of different categories from a variety of sources. Among these sources are commercial data, i.e., increased prescriptions of particular product, business outcomes analyses, i.e., based on the Scorecard information, internal services provided to the MTL, and survey results.

Direct Analysis

The impact of MSL activities may be measured in commercial terms. By targeting MSL efforts toward a select group of physicians/outcomes, the conditions are met to enable comparison of product prescribing between the targeted physicians/institutions and the relevant physician/institution universe. For example, to examine the impact of MSL activities, the targeted customer's product utilization uptake can be compared to the appropriate customer universe. More rapid uptake would result in an increase in the slope of the sales curve over the time since launch, compared to the slope of the sales curve of the comparator population. Historically, the rate of market uptake following launch is a major determinant of total sales over the commercial life of the drug.

Indirect Analysis

The statistical tests (e.g., ANCOVA) detect variables that co-vary (in this case, activity types and business outcome types) with a given outcome status (achieved or non-achieved). This permits objective measurement of the effort required to achieve a targeted business outcome, thereby increasing the accuracy of MSL capacity assessments and commercial planning efforts. During the Evaluating phase, the data pertaining to business outcomes, and activities conducted in the attempt to achieve these outcomes, is analyzed. The analyses determine which activities and at what frequency/duration resulted in achieved outcomes, versus those activities and frequency/duration that resulted in non-achievement of a targeted outcome. The determination is accomplished through conducting a statistical analysis that provides the aggregate weight of individual activity types for a specific business outcome type differentiated by achievement and non-achievement.

Tables 7 and 8 illustrate a statistical analysis of the average frequency of interactions by activity type with respect to achievement and non-achievement of an investigator outcome based on the data in Table 4.

TABLE 7
Statistical Analysis of Investigator Outcome Data

| | Outcome | | | |
|---|---|---|---|---|
| Business | Achieved | | Average | |
| Outcome | (Y/N) | Data | Interactions | StdDevP |
| Investigator | N | Average of | 2.412 | 0.771 |
| | | RECRUIT | | |
| Investigator | N | Average of | | |
| | | COACH | | |
| Investigator | N | Average of | 3.238 | 0.610 |
| | | REL | | |
| Investigator | N | Average of | 1.000 | 0.000 |
| | | NET | | |
| Investigator | N | Average of | 1.000 | 0.000 |
| | | ASSESS | | |
| Investigator | N | Average of | | |
| | | BUSSOL | | |
| Investigator | N | Average of | | |
| | | MEDSOL | | |
| Investigator | N | Average of | 1.857 | 0.774 |
| | | KX | | |
| Investigator | Y | Average of | 1.056 | 0.229 |
| | | RECRUIT | | |
| Investigator | Y | Average of | 1.000 | 0.000 |
| | | COACH | | |
| Investigator | Y | Average of | 2.667 | 0.943 |
| | | REL | | |
| Investigator | Y | Average of | 1.000 | 0.000 |
| | | NET | | |
| Investigator | Y | Average of | 1.000 | 0.000 |
| | | ASSESS | | |
| Investigator | Y | Average of | 1.000 | 0.000 |
| | | BUSSOL | | |
| Investigator | Y | Average of | 1.000 | 0.000 |
| | | MEDSOL | | |
| Investigator | Y | Average of | 2.444 | 1.165 |
| | | KX | | |

| | | |
|---|---|---|
| Investigator Average of RECRUIT | 1.714 | 0.881 |
| Investigator Average of COACH | 1.000 | 0.000 |
| Investigator Average of REL | 2.974 | 0.832 |
| Investigator Average of NET | 1.000 | 0.000 |
| Investigator Average of ASSESS | 1.000 | 0.000 |
| Investigator Average of BUSSOL | 1.000 | 0.000 |
| Investigator Average of MEDSOL | 1.000 | 0.000 |
| Investigator Average of KX | 2.128 | 1.017 |
| Total Average of RECRUIT | 1.714 | 0.881 |
| Total Average of COACH | 1.000 | 0.000 |
| Total Average of REL | 2.974 | 0.832 |
| Total Average of NET | 1.000 | 0.000 |
| Total Average of ASSESS | 1.000 | 0.000 |
| Total Average of BUSSOL | 1.000 | 0.000 |
| Total Average of MEDSOL | 1.000 | 0.000 |
| Total Average of KX | 2.128 | 1.017 |

TABLE 8

| N Data | N Data | | Sum of | | |
|---|---|---|---|---|---|
| Average | StdDevP | Difference | StdDevPs | Significance | |
| 2.412 | 0.771 | −1.356 | 1.000 | S− | RECRUIT** |
| | | 1.000 | 0.000 | S+ | COACH** |
| 3.238 | 0.61 | −0.571 | 1.553 | NS | REL |
| 1 | 0 | 0.000 | 0.000 | NS | NET |
| 1 | 0 | 0.000 | 0.000 | NS | ASSESS |
| | | 1.000 | 0.000 | S+ | BUSSOL** |
| | | 1.000 | 0.000 | S+ | MEDSOL** |
| 1.857 | 0.774 | 0.587 | 1.939 | NS | KX |

**Considered Significant if StdDevPs do not overlap
Significance (significant effect defined as the difference between the means is greater than the sum of the combined StdDevPs; if the StdDevP = 0, then use the Combined StdDevP instead):
NS = Non-Significant
S− = Significant Negative Result
S+ = Significant Positive Result

Several conclusions may be drawn from the statistical analyses in Tables 7 and 8. For example, the data average for recruiting type activity suggests that if the MSL does not get a commitment after two recruiting interactions, then an investigator outcome is highly unlikely. Also, based on this exemplary data, coaching, medical solutions and business solutions interactions improve the likelihood of a successful investigator outcome. The data suggest that a successful approach to achieve an investigator outcome may be obtained through the following set of interactions:

| | |
|---|---|
| 1.056 | RECRUIT interactions |
| 1.000 | COACH interactions |
| 2.667 | REL interactions |
| 1.000 | NET interactions |
| 1.000 | ASSESS interactions |
| 1.000 | BUSSOL interactions |
| 1.000 | MEDSOL interactions |
| 2.444 | KX interactions |
| 11.167 | Total interactions plus or minus 3.111 |

A statistical analysis based on duration rather than frequency of interactions and activity types may also be derived from the data in a similar manner.

Tables 9 and 10 illustrate a sample data and statistical analysis report for a second exemplary set of interactions in which multiple business outcomes were targeted over a predetermined period of time.

TABLE 9
CRM Data for All MTL and All Targeted Business Outcomes

| | | | | | Targeted | Outcome |
|---|---|---|---|---|---|---|
| Interaction | MTL Last | MTL First | | Duration of | Business | Achieved |
| Date | Name | Name | Activity Type | Interaction | Outcome | (Y/N)? |
| Jan. 5, 2002 | Adams | Joan | REL | 30 | Author | N |
| Feb. 7, 2002 | Adams | Joan | KX | 25 | Author | N |
| Mar. 8, 2002 | Adams | Joan | KX | 10 | Author | N |
| Apr. 2, 2002 | Adams | Joan | KX | 40 | Author | N |
| May 10, 2002 | Adams | Joan | RECRUIT | 60 | Author | N |
| Jun. 3, 2002 | Adams | Joan | REL | 120 | Author | Y |
| Jul. 9, 2002 | Adams | Joan | KX | 50 | Author | M |
| Aug. 2, 2002 | Adams | Joan | KX | 40 | Author | M |
| Aug. 28, 2002 | Adams | Joan | NET | 45 | Author | M |
| Jan. 5, 2002 | Aden | A | REL | 40 | Consultant | N |
| Feb. 14, 2002 | Aden | A | KX | 60 | Consultant | N |
| Mar. 19, 2002 | Aden | A | RECRUIT | 120 | Consultant | N |
| May 18, 2002 | Aden | A | RECRUIT | 50 | Consultant | N |
| Jun. 24, 2002 | Aden | A | REL | 20 | Consultant | N |
| Aug. 2, 2002 | Aden | A | KX | 40 | Consultant | Y |
| Jan. 5, 2002 | Benek | James | REL | 120 | Consultant | N |
| Feb. 7, 2002 | Benek | James | REL | 50 | Consultant | N |
| Mar. 8, 2002 | Benek | James | KX | 20 | Consultant | N |
| Apr. 2, 2002 | Benek | James | RECRUIT | 40 | Consultant | N |
| May 10, 2002 | Benek | James | RECRUIT | 60 | Consultant | N |
| Jun. 3, 2002 | Benek | James | KX | 30 | Consultant | N |
| Jul. 9, 2002 | Benek | James | REL | 25 | Consultant | N |
| Aug. 2, 2002 | Benek | James | KX | 10 | Consultant | N |
| Aug. 28, 2002 | Benek | James | REL | 40 | Consultant | N |
| Jan. 5, 2002 | Casey | N | REL | 10 | Consultant | N |
| Feb. 7, 2002 | Casey | N | KX | 40 | Consultant | N |
| Mar. 9, 2002 | Casey | N | REL | 60 | Consultant | N |
| Apr. 2, 2002 | Casey | N | RECRUIT | 120 | Consultant | N |
| May 15, 2002 | Casey | N | RECRUIT | 50 | Consultant | N |
| Jun. 24, 2002 | Casey | N | REL | 20 | Consultant | N |
| Jul. 20, 2002 | Casey | N | RECRUIT | 40 | Consultant | N |
| Aug. 2, 2002 | Casey | N | KX | 60 | Consultant | N |
| Aug. 28, 2002 | Casey | N | REL | 30 | Consultant | N |
| Jan. 5, 2002 | Dodds | Kenneth | REL | 50 | Author | N |
| Feb. 7, 2002 | Dodds | Kenneth | KX | 20 | Author | N |
| Mar. 8, 2002 | Dodds | Kenneth | RECRUIT | 40 | Author | N |
| Apr. 2, 2002 | Dodds | Kenneth | REL | 60 | Author | N |
| May 15, 2002 | Dodds | Kenneth | KX | 30 | Author | N |
| Jun. 24, 2002 | Dodds | Kenneth | KX | 25 | Author | N |
| Jul. 20, 2002 | Dodds | Kenneth | KX | 10 | Author | N |
| Aug. 2, 2002 | Dodds | Kenneth | KX | 40 | Author | Y |
| Aug. 28, 2002 | Dodds | Kenneth | REL | 60 | Author | M |
| Jan. 4, 2002 | Emrick | Michel | REL | 120 | Investigator | N |
| Feb. 7, 2002 | Emrick | Michel | KX | 50 | Investigator | N |
| Mar. 9, 2002 | Emrick | Michel | RECRUIT | 20 | Investigator | N |
| Apr. 2, 2002 | Emrick | Michel | RECRUIT | 40 | Investigator | N |
| May 15, 2002 | Emrick | Michel | REL | 60 | Investigator | N |
| Jun. 24, 2002 | Emrick | Michel | REL | 30 | Investigator | N |
| Jul. 20, 2002 | Emrick | Michel | RECRUIT | 25 | Investigator | N |
| Aug. 2, 2002 | Emrick | Michel | KX | 10 | Investigator | N |
| Aug. 28, 2002 | Emrick | Michel | RECRUIT | 40 | Investigator | N |
| Jan. 4, 2002 | Fitch | Raymond | REL | 25 | Investigator | N |
| Feb. 7, 2002 | Fitch | Raymond | RECRUIT | 10 | Investigator | N |
| Mar. 8, 2002 | Fitch | Raymond | ASSESS | 40 | Investigator | N |
| Apr. 2, 2002 | Fitch | Raymond | KX | 60 | Investigator | N |
| May 10, 2002 | Fitch | Raymond | REL | 120 | Investigator | N |
| Jun. 3, 2002 | Fitch | Raymond | NET | 50 | Investigator | N |
| Jul. 9, 2002 | Fitch | Raymond | REL | 20 | Investigator | Y |
| Jul. 20, 2002 | Fitch | Raymond | KX | 40 | Investigator | M |
| Aug. 28, 2002 | Fitch | Raymond | KX | 60 | Investigator | M |
| Jan. 5, 2002 | Gerber | M | REL | 20 | Prescriber | N |
| Feb. 14, 2002 | Gerber | M | KX | 40 | Prescriber | N |
| Mar. 19, 2002 | Gerber | M | REL | 60 | Prescriber | N |
| May 18, 2002 | Gerber | M | NET | 30 | Prescriber | N |
| Jun. 24, 2002 | Gerber | M | REL | 25 | Prescriber | Y |
| Aug. 2, 2002 | Gerber | M | REL | 10 | Prescriber | M |
| Jan. 5, 2002 | Hicks | Melissa | REL | 30 | Prescriber | N |
| Mar. 19, 2002 | Hicks | Melissa | REL | 25 | Prescriber | N |
| May 18, 2002 | Hicks | Melissa | REL | 10 | Prescriber | N |
| Jun. 24, 2002 | Hicks | Melissa | KX | 40 | Prescriber | Y |
| Aug. 2, 2002 | Hicks | Melissa | KX | 60 | Prescriber | M |
| Aug. 28, 2002 | Hicks | Melissa | KX | 120 | Prescriber | M |
| Jan. 4, 2002 | Howe | Tausee | REL | 40 | Prescriber | N |
| Feb. 7, 2002 | Howe | Tausee | REL | 60 | Prescriber | N |
| Mar. 8, 2002 | Howe | Tausee | KX | 120 | Prescriber | N |
| Apr. 2, 2002 | Howe | Tausee | KX | 50 | Prescriber | N |
| May 10, 2002 | Howe | Tausee | KX | 20 | Prescriber | N |
| Jun. 8, 2002 | Howe | Tausee | REL | 40 | Prescriber | N |
| Jul. 9, 2002 | Howe | Tausee | NET | 60 | Prescriber | N |
| Aug. 2, 2002 | Howe | Tausee | MEDSOL | 30 | Prescriber | Y |
| Aug. 28, 2002 | Howe | Tausee | REL | 25 | Prescriber | M |
| Jan. 4, 2002 | Keeler | Bart | REL | 60 | Speaker | N |
| Feb. 7, 2002 | Keeler | Bart | KX | 120 | Speaker | N |
| Mar. 8, 2002 | Keeler | Bart | RECRUIT | 50 | Speaker | N |
| Apr. 2, 2002 | Keeler | Bart | KX | 20 | Speaker | N |
| May 10, 2002 | Keeler | Bart | REL | 40 | Speaker | N |
| Jun. 3, 2002 | Keeler | Bart | COACH | 60 | Speaker | N |
| Jul. 9, 2002 | Keeler | Bart | KX | 30 | Speaker | N |
| Jul. 20, 2002 | Keeler | Bart | REL | 25 | Speaker | Y |
| Aug. 28, 2002 | Keeler | Bart | REL | 10 | Speaker | M |
| Jan. 4, 2002 | Lucas | Emmanuel | REL | 60 | Speaker | N |
| Feb. 14, 2002 | Lucas | Emmanuel | KX | 120 | Speaker | N |
| Mar. 19, 2002 | Lucas | Emmanuel | RECRUIT | 50 | Speaker | N |
| May 18, 2002 | Lucas | Emmanuel | RECRUIT | 20 | Speaker | N |
| Jun. 24, 2002 | Lucas | Emmanuel | REL | 40 | Speaker | N |
| Aug. 2, 2002 | Lucas | Emmanuel | REL | 60 | Speaker | N |
| Jan. 4, 2002 | Markley | William | REL | 60 | Speaker | N |
| Feb. 14, 2002 | Markley | William | RECRUIT | 30 | Speaker | N |
| Mar. 19, 2002 | Markley | William | RECRUIT | 25 | Speaker | N |
| May 18, 2002 | Markley | William | KX | 10 | Speaker | N |
| Jun. 24, 2002 | Markley | William | REL | 40 | Speaker | N |
| Aug. 2, 2002 | Markley | William | REL | 60 | Speaker | N |
| Jan. 5, 2002 | Martin | Joan | REL | 30 | Author | N |
| Feb. 7, 2002 | Martin | Joan | KX | 25 | Author | N |
| Mar. 8, 2002 | Martin | Joan | KX | 10 | Author | N |
| Apr. 2, 2002 | Martin | Joan | KX | 40 | Author | N |
| May 10, 2002 | Martin | Joan | RECRUIT | 60 | Author | N |
| Jun. 3, 2002 | Martin | Joan | REL | 120 | Author | Y |
| Jul. 9, 2002 | Martin | Joan | KX | 50 | Author | M |
| Aug. 2, 2002 | Martin | Joan | KX | 40 | Author | M |
| Aug. 28, 2002 | Martin | Joan | NET | 45 | Author | M |
| Jan. 5, 2002 | Metzger | A | REL | 40 | Consultant | N |
| Feb. 14, 2002 | Metzger | A | KX | 60 | Consultant | N |
| Mar. 19, 2002 | Metzger | A | RECRUIT | 120 | Consultant | N |
| May 18, 2002 | Metzger | A | RECRUIT | 50 | Consultant | N |
| Jun. 24, 2002 | Metzger | A | REL | 20 | Consultant | N |
| Aug. 2, 2002 | Metzger | A | KX | 40 | Consultant | Y |
| Jan. 5, 2002 | Milnes | James | REL | 120 | Consultant | N |
| Feb. 7, 2002 | Milnes | James | REL | 50 | Consultant | N |
| Mar. 8, 2002 | Milnes | James | KX | 20 | Consultant | N |
| Apr. 2, 2002 | Milnes | James | RECRUIT | 40 | Consultant | N |
| May 10, 2002 | Milnes | James | RECRUIT | 60 | Consultant | N |
| Jun. 3, 2002 | Milnes | James | KX | 30 | Consultant | N |
| Jul. 9, 2002 | Milnes | James | REL | 25 | Consultant | N |
| Aug. 2, 2002 | Milnes | James | KX | 10 | Consultant | N |
| Aug. 28, 2002 | Milnes | James | REL | 40 | Consultant | N |
| Jan. 5, 2002 | Myers | N | REL | 10 | Consultant | N |
| Feb. 7, 2002 | Myers | N | KX | 40 | Consultant | N |
| Mar. 9, 2002 | Myers | N | REL | 60 | Consultant | N |
| Apr. 2, 2002 | Myers | N | RECRUIT | 120 | Consultant | N |
| May 15, 2002 | Myers | N | RECRUIT | 50 | Consultant | N |
| Jun. 24, 2002 | Myers | N | REL | 20 | Consultant | N |
| Jul. 20, 2002 | Myers | N | RECRUIT | 40 | Consultant | N |
| Aug. 2, 2002 | Myers | N | KX | 60 | Consultant | N |
| Aug. 28, 2002 | Myers | N | REL | 30 | Consultant | N |
| Jan. 5, 2002 | Nichols | Kenneth | REL | 50 | Author | N |
| Feb. 7, 2002 | Nichols | Kenneth | KX | 20 | Author | N |
| Mar. 8, 2002 | Nichols | Kenneth | RECRUIT | 40 | Author | N |
| Apr. 2, 2002 | Nichols | Kenneth | REL | 60 | Author | N |
| May 15, 2002 | Nichols | Kenneth | KX | 30 | Author | N |
| Jun. 24, 2002 | Nichols | Kenneth | KX | 25 | Author | N |
| Jul. 20, 2002 | Nichols | Kenneth | KX | 10 | Author | N |
| Aug. 2, 2002 | Nichols | Kenneth | KX | 40 | Author | Y |
| Aug. 28, 2002 | Nichols | Kenneth | REL | 60 | Author | M |
| Jan. 4, 2002 | Nolan | Michel | REL | 120 | Investigator | N |
| Feb. 7, 2002 | Nolan | Michel | KX | 50 | Investigator | N |
| Mar. 9, 2002 | Nolan | Michel | RECRUIT | 20 | Investigator | N |
| Apr. 2, 2002 | Nolan | Michel | RECRUIT | 40 | Investigator | N |
| May 15, 2002 | Nolan | Michel | REL | 60 | Investigator | N |
| Jun. 24, 2002 | Nolan | Michel | REL | 30 | Investigator | N |
| Jul. 20, 2002 | Nolan | Michel | RECRUIT | 25 | Investigator | N |
| Aug. 2, 2002 | Nolan | Michel | KX | 10 | Investigator | N |
| Aug. 28, 2002 | Nolan | Michel | RECRUIT | 40 | Investigator | N |
| Jan. 4, 2002 | Osborne | Raymond | REL | 25 | Investigator | N |
| Feb. 7, 2002 | Osborne | Raymond | RECRUIT | 10 | Investigator | N |
| Mar. 8, 2002 | Osborne | Raymond | ASSESS | 40 | Investigator | N |
| Apr. 2, 2002 | Osborne | Raymond | KX | 60 | Investigator | N |
| May 10, 2002 | Osborne | Raymond | REL | 120 | Investigator | N |
| Jun. 3, 2002 | Osborne | Raymond | NET | 50 | Investigator | N |
| Jul. 9, 2002 | Osborne | Raymond | REL | 20 | Investigator | Y |
| Jul. 20, 2002 | Osborne | Raymond | KX | 40 | Investigator | M |
| Aug. 28, 2002 | Osborne | Raymond | KX | 60 | Investigator | M |
| Jan. 5, 2002 | Owens | M | REL | 20 | Prescriber | N |
| Feb. 14, 2002 | Owens | M | KX | 40 | Prescriber | N |
| Mar. 19, 2002 | Owens | M | REL | 60 | Prescriber | N |
| May 18, 2002 | Owens | M | NET | 30 | Prescriber | N |
| Jun. 24, 2002 | Owens | M | REL | 25 | Prescriber | Y |
| Aug. 2, 2002 | Owens | M | REL | 10 | Prescriber | M |
| Jan. 5, 2002 | Padva | Melissa | REL | 30 | Prescriber | N |
| Mar. 19, 2002 | Padva | Melissa | REL | 25 | Prescriber | N |
| May 18, 2002 | Padva | Melissa | REL | 10 | Prescriber | N |
| Jun. 24, 2002 | Padva | Melissa | KX | 40 | Prescriber | Y |
| Aug. 2, 2002 | Padva | Melissa | KX | 60 | Prescriber | M |
| Aug. 28, 2002 | Padva | Melissa | KX | 120 | Prescriber | M |
| Jan. 4, 2002 | Patterson | Tausee | REL | 40 | Prescriber | N |
| Feb. 7, 2002 | Patterson | Tausee | REL | 60 | Prescriber | N |
| Mar. 8, 2002 | Patterson | Tausee | KX | 120 | Prescriber | N |
| Apr. 2, 2002 | Patterson | Tausee | KX | 50 | Prescriber | N |
| May 10, 2002 | Patterson | Tausee | KX | 20 | Prescriber | N |
| Jun. 8, 2002 | Patterson | Tausee | REL | 40 | Prescriber | N |
| Jul. 9, 2002 | Patterson | Tausee | NET | 60 | Prescriber | N |
| Aug. 2, 2002 | Patterson | Tausee | MEDSOL | 30 | Prescriber | Y |
| Aug. 28, 2002 | Patterson | Tausee | REL | 25 | Prescriber | M |
| Jan. 4, 2002 | Petty | Bart | REL | 60 | Speaker | N |
| Feb. 7, 2002 | Petty | Bart | KX | 120 | Speaker | N |
| Mar. 8, 2002 | Petty | Bart | RECRUIT | 50 | Speaker | N |
| Apr. 2, 2002 | Petty | Bart | KX | 20 | Speaker | N |
| May 10, 2002 | Petty | Bart | REL | 40 | Speaker | N |
| Jun. 3, 2002 | Petty | Bart | COACH | 60 | Speaker | N |
| Jul. 9, 2002 | Petty | Bart | KX | 30 | Speaker | N |
| Jul. 20, 2002 | Petty | Bart | REL | 25 | Speaker | Y |
| Aug. 28, 2002 | Petty | Bart | REL | 10 | Speaker | M |
| Jan. 4, 2002 | Philbin | Emmanuel | REL | 6.0 | Speaker | N |
| Feb. 14, 2002 | Philbin | Emmanuel | KX | 120 | Speaker | N |
| Mar. 19, 2002 | Philbin | Emmanuel | RECRUIT | 50 | Speaker | N |
| May 18, 2002 | Philbin | Emmanuel | RECRUIT | 20 | Speaker | N |
| Jun. 24, 2002 | Philbin | Emmanuel | REL | 40 | Speaker | N |
| Aug. 2, 2002 | Philbin | Emmanuel | REL | 60 | Speaker | N |
| Jan. 4, 2002 | Pollack | William | REL | 60 | Speaker | N |
| Feb. 14, 2002 | Pollack | William | RECRUIT | 30 | Speaker | N |
| Mar. 19, 2002 | Pollack | William | RECRUIT | 25 | Speaker | N |
| May 18, 2002 | Pollack | William | KX | 10 | Speaker | N |
| Jun. 24, 2002 | Pollack | William | REL | 40 | Speaker | N |
| Aug. 2, 2002 | Pollack | William | REL | 60 | Speaker | N |
| Jan. 5, 2002 | Potter | Joan | REL | 30 | Formulary | N |
| | | | | | Supporter | |
| Feb. 7, 2002 | Potter | Joan | KX | 25 | Formulary | N |
| | | | | | Supporter | |
| Mar. 8, 2002 | Potter | Joan | KX | 10 | Formulary | N |
| | | | | | Supporter | |
| Apr. 2, 2002 | Potter | Joan | KX | 40 | Formulary | N |
| | | | | | Supporter | |
| May 10, 2002 | Potter | Joan | RECRUIT | 60 | Formulary | N |
| | | | | | Supporter | |
| Jun. 3, 2002 | Potter | Joan | REL | 120 | Formulary | Y |
| | | | | | Supporter | |
| Jul. 9, 2002 | Potter | Joan | KX | 50 | Formulary | M |
| | | | | | Supporter | |
| Aug. 2, 2002 | Potter | Joan | KX | 40 | Formulary | M |
| | | | | | Supporter | |
| Aug. 28, 2002 | Potter | Joan | NET | 45 | Formulary | M |
| | | | | | Supporter | |
| Jan. 5, 2002 | Ramsey | A | REL | 40 | Consultant | N |
| Feb. 14, 2002 | Ramsey | A | KX | 60 | Consultant | N |
| Mar. 19, 2002 | Ramsey | A | RECRUIT | 120 | Consultant | N |
| May 18, 2002 | Ramsey | A | RECRUIT | 50 | Consultant | N |
| Jun. 24, 2002 | Ramsey | A | REL | 20 | Consultant | N |
| Aug. 2, 2002 | Ramsey | A | KX | 40 | Consultant | Y |
| Jan. 5, 2002 | Reinhart | James | REL | 120 | Formulary | N |
| | | | | | Supporter | |
| Feb. 7, 2002 | Reinhart | James | REL | 50 | Formulary | N |
| | | | | | Supporter | |
| Mar. 8, 2002 | Reinhart | James | KX | 20 | Formulary | N |
| | | | | | Supporter | |
| Apr. 2, 2002 | Reinhart | James | RECRUIT | 40 | Formulary | N |
| | | | | | Supporter | |
| May 10, 2002 | Reinhart | James | RECRUIT | 60 | Formulary | N |
| | | | | | Supporter | |
| Jun. 3, 2002 | Reinhart | James | KX | 30 | Formulary | N |
| | | | | | Supporter | |
| Jul. 9, 2002 | Reinhart | James | REL | 25 | Formulary | N |
| | | | | | Supporter | |
| Aug. 2, 2002 | Reinhart | James | KX | 10 | Formulary | N |
| | | | | | Supporter | |
| Aug. 28, 2002 | Reinhart | James | REL | 40 | Formulary | N |
| | | | | | Supporter | |
| Jan. 5, 2002 | Richards | N | REL | 10 | Consultant | N |
| Feb. 7, 2002 | Richards | N | KX | 40 | Consultant | N |
| Mar. 9, 2002 | Richards | N | REL | 60 | Consultant | N |
| Apr. 2, 2002 | Richards | N | RECRUIT | 120 | Consultant | N |
| May 15, 2002 | Richards | N | RECRUIT | 50 | Consultant | N |
| Jun. 24, 2002 | Richards | N | REL | 20 | Consultant | N |
| Jul. 20, 2002 | Richards | N | RECRUIT | 40 | Consultant | N |
| Aug. 2, 2002 | Richards | N | KX | 60 | Consultant | N |
| Aug. 28, 2002 | Richards | N | REL | 30 | Consultant | N |
| Jan. 5, 2002 | Rosen | Kenneth | REL | 50 | Author | N |
| Feb. 7, 2002 | Rosen | Kenneth | KX | 20 | Author | N |
| Mar. 8, 2002 | Rosen | Kenneth | RECRUIT | 40 | Author | N |
| Apr. 2, 2002 | Rosen | Kenneth | REL | 60 | Author | N |
| May 15, 2002 | Rosen | Kenneth | KX | 30 | Author | N |
| Jun. 24, 2002 | Rosen | Kenneth | KX | 25 | Author | N |
| Jul. 20, 2002 | Rosen | Kenneth | KX | 10 | Author | N |
| Aug. 2, 2002 | Rosen | Kenneth | KX | 40 | Author | Y |
| Aug. 28, 2002 | Rosen | Kenneth | REL | 60 | Author | M |
| Jan. 4, 2002 | Ryan | Michel | REL | 120 | Investigator | N |
| Feb. 7, 2002 | Ryan | Michel | KX | 50 | Investigator | N |
| Mar. 9, 2002 | Ryan | Michel | RECRUIT | 20 | Investigator | N |
| Apr. 2, 2002 | Ryan | Michel | RECRUIT | 40 | Investigator | N |
| May 15, 2002 | Ryan | Michel | REL | 60 | Investigator | N |
| Jun. 24, 2002 | Ryan | Michel | REL | 30 | Investigator | N |
| Jul. 20, 2002 | Ryan | Michel | RECRUIT | 25 | Investigator | N |
| Aug. 2, 2002 | Ryan | Michel | KX | 10 | Investigator | N |
| Aug. 28, 2002 | Ryan | Michel | RECRUIT | 40 | Investigator | N |
| Jan. 4, 2002 | Saxton | Raymond | REL | 25 | Formulary | N |
| | | | | | Supporter | |
| Feb. 7, 2002 | Saxton | Raymond | RECRUIT | 10 | Formulary | N |
| | | | | | Supporter | |
| Mar. 8, 2002 | Saxton | Raymond | RECRUIT | 40 | Formulary | N |
| | | | | | Supporter | |
| Apr. 2, 2002 | Saxton | Raymond | KX | 60 | Formulary | N |
| | | | | | Supporter | |
| May 10, 2002 | Saxton | Raymond | REL | 120 | Formulary | N |
| | | | | | Supporter | |
| Jun. 3, 2002 | Saxton | Raymond | NET | 50 | Formulary | N |
| | | | | | Supporter | |
| Jul. 9, 2002 | Saxton | Raymond | REL | 20 | Formulary | N |
| | | | | | Supporter | |
| Jul. 20, 2002 | Saxton | Raymond | KX | 40 | Formulary | N |
| | | | | | Supporter | |
| Aug. 28, 2002 | Saxton | Raymond | KX | 60 | Formulary | N |
| | | | | | Supporter | |
| Jan. 5, 2002 | Schmitt | M | REL | 20 | Prescriber | N |
| Feb. 14, 2002 | Schmitt | M | KX | 40 | Prescriber | N |
| Mar. 19, 2002 | Schmitt | M | REL | 60 | Prescriber | N |
| May 18, 2002 | Schmitt | M | NET | 30 | Prescriber | N |
| Jun. 24, 2002 | Schmitt | M | REL | 25 | Prescriber | Y |
| Aug. 2, 2002 | Schmitt | M | REL | 10 | Prescriber | M |
| Jan. 5, 2002 | Stewart | Melissa | REL | 30 | Prescriber | N |
| Mar. 19, 2002 | Stewart | Melissa | REL | 25 | Prescriber | N |
| May 18, 2002 | Stewart | Melissa | REL | 10 | Prescriber | N |
| Jun. 24, 2002 | Stewart | Melissa | KX | 40 | Prescriber | N |
| Aug. 2, 2002 | Stewart | Melissa | KX | 60 | Prescriber | N |
| Aug. 28, 2002 | Stewart | Melissa | KX | 120 | Prescriber | N |
| Jan. 4, 2002 | Thompson | Tausee | REL | 40 | Prescriber | N |
| Feb. 7, 2002 | Thompson | Tausee | REL | 60 | Prescriber | N |
| Mar. 8, 2002 | Thompson | Tausee | KX | 120 | Prescriber | N |
| Apr. 2, 2002 | Thompson | Tausee | KX | 50 | Prescriber | N |
| May 10, 2002 | Thompson | Tausee | KX | 20 | Prescriber | N |
| Jun. 8, 2002 | Thompson | Tausee | REL | 40 | Prescriber | N |
| Jul. 9, 2002 | Thompson | Tausee | NET | 60 | Prescriber | N |
| Aug. 2, 2002 | Thompson | Tausee | REL | 30 | Prescriber | N |
| Aug. 28, 2002 | Thompson | Tausee | REL | 25 | Prescriber | N |
| Jan. 4, 2002 | Ulshafer | Bart | REL | 60 | Speaker | N |
| Feb. 7, 2002 | Ulshafer | Bart | KX | 120 | Speaker | N |
| Mar. 8, 2002 | Ulshafer | Bart | RECRUIT | 50 | Speaker | N |
| Apr. 2, 2002 | Ulshafer | Bart | KX | 20 | Speaker | N |
| May 10, 2002 | Ulshafer | Bart | REL | 40 | Speaker | N |
| Jun. 3, 2002 | Ulshafer | Bart | COACH | 60 | Speaker | N |
| Jul. 9, 2002 | Ulshafer | Bart | KX | 30 | Speaker | N |
| Jul. 20, 2002 | Ulshafer | Bart | REL | 25 | Speaker | Y |
| Aug. 28, 2002 | Ulshafer | Bart | REL | 10 | Speaker | M |
| Jan. 4, 2002 | Vogel | Emmanuel | REL | 60 | Speaker | N |
| Feb. 14, 2002 | Vogel | Emmanuel | KX | 120 | Speaker | N |
| Mar. 19, 2002 | Vogel | Emmanuel | RECRUIT | 50 | Speaker | N |
| May 18, 2002 | Vogel | Emmanuel | RECRUIT | 20 | Speaker | N |
| Jun. 24, 2002 | Vogel | Emmanuel | REL | 40 | Speaker | N |
| Aug. 2, 2002 | Vogel | Emmanuel | REL | 60 | Speaker | N |
| Jan. 4, 2002 | Wellington | William | REL | 60 | Speaker | N |
| Feb. 14, 2002 | Wellington | William | RECRUIT | 30 | Speaker | N |
| Mar. 19, 2002 | Wellington | William | RECRUIT | 25 | Speaker | N |
| May 18, 2002 | Wellington | William | KX | 10 | Speaker | N |
| Jun. 24, 2002 | Wellington | William | REL | 40 | Speaker | N |
| Aug. 2, 2002 | Wellington | William | REL | 60 | Speaker | N |

TABLE 10
Statistical Analysis for Multiple Targeted Business Outcomes

| | Outcome | | | | |
|---|---|---|---|---|---|
| Business Outcome | Achieved | Data | Average | StdDevP | |
| Author | 1 | Average of BUSSOL | | | |
| Author | 1 | Average of MEDSOL | | | |
| Author | 1 | Average of KX | 4.20 | 0.98 | |
| Author | 1 | Average of RECRUIT | 1.00 | 0.00 | |
| Author | 1 | Average of COACH | | | |
| Author | 1 | Average of REL | 2.00 | 0.00 | |
| Author | 1 | Average of NET | | | |
| Author | 1 | Average of ASSESS | | | |
| Author | 1 | Author Average of BUSSOL | | | |
| Author | 1 | Author Average of MEDSOL | | | |
| Author | 1 | Author Average of KX | 4.20 | 0.98 | |
| Author | 1 | Author Average of RECRUIT | 1.00 | 0.00 | |
| Author | 1 | Author Average of COACH | | | |
| Author | 1 | Author Average of REL | 2.00 | 0.00 | |
| Author | 1 | Author Average of NET | | | |
| Author | 1 | Author Average of ASSESS | | | |
| Consultant | 0 | Average of BUSSOL | | | |
| Consultant | 0 | Average of MEDSOL | | | |
| Consultant | 0 | Average of KX | 2.40 | 0.49 | |
| Consultant | 0 | Average of RECRUIT | 2.60 | 0.49 | |
| Consultant | 0 | Average of COACH | | | |
| Consultant | 0 | Average of REL | 4.00 | 0.00 | |
| Consultant | 0 | Average of NET | | | |
| Consultant | 0 | Average of ASSESS | | | |
| Consultant | 1 | Average of BUSSOL | | | |
| Consultant | 1 | Average of MEDSOL | | | |
| Consultant | 1 | Average of KX | 2.00 | 0.00 | |
| Consultant | 1 | Average of RECRUIT | 2.00 | 0.00 | |
| Consultant | 1 | Average of COACH | | | |
| Consultant | 1 | Average of REL | 2.00 | 0.00 | |
| Consultant | 1 | Average of NET | | | |
| Consultant | 1 | Average of ASSESS | | | |
| Consultant | 2 | Consultant Average of BUSSOL | | | |
| Consultant | 2 | Consultant Average of MEDSOL | | | |
| Consultant | 2 | Consultant Average of KX | 2.25 | 0.43 | NS |
| Consultant | 2 | Consultant Average of RECRUIT | 2.38 | 0.48 | S − |
| Consultant | 2 | Consultant Average of COACH | | | |
| Consultant | 2 | Consultant Average of REL | 3.25 | 0.97 | S − |
| Consultant | 2 | Consultant Average of NET | | | |
| Consultant | 2 | Consultant Average of ASSESS | | | |
| Formulary Supporter | 0 | Average of BUSSOL | | | |
| Formulary Supporter | 0 | Average of MEDSOL | | | |
| Formulary Supporter | 0 | Average of KX | 3.00 | 0.00 | |
| Formulary Supporter | 0 | Average of RECRUIT | 2.00 | 0.00 | |
| Formulary Supporter | 0 | Average of COACH | | | |
| Formulary Supporter | 0 | Average of REL | 3.50 | 0.50 | |
| Formulary Supporter | 0 | Average of NET | 1.00 | 0.00 | |
| Formulary Supporter | 0 | Average of ASSESS | | | |
| Formulary Supporter | 1 | Average of BUSSOL | | | |
| Formulary Supporter | 1 | Average of MEDSOL | | | |
| Formulary Supporter | 1 | Average of KX | 3.00 | 0.00 | |
| Formulary Supporter | 1 | Average of RECRUIT | 1.00 | 0.00 | |
| Formulary Supporter | 1 | Average of COACH | | | |
| Formulary Supporter | 1 | Average of REL | 2.00 | 0.00 | |
| Formulary Supporter | 1 | Average of NET | | | |
| Formulary Supporter | 1 | Average of ASSESS | | | |
| Formulary Supporter | 2 | Formulary Supporter Average of BUSSOL | | | |
| Formulary Supporter | 2 | Formulary Supporter Average of MEDSOL | | | |
| Formulary Supporter | 2 | Formulary Supporter Average of KX | 3.00 | 0.00 | NS |
| Formulary Supporter | 2 | Formulary Supporter Average of RECRUIT | 1.67 | 0.47 | S − |
| Formulary Supporter | 2 | Formulary Supporter Average of COACH | | | |
| Formulary Supporter | 2 | Formulary Supporter Average of REL | 3.00 | 0.82 | S − |
| Formulary Supporter | 2 | Formulary Supporter Average of NET | 1.00 | 0.00 | S − |
| Formulary Supporter | 2 | Formulary Supporter Average of ASSESS | | | |
| Investigator | 0 | Average of BUSSOL | | | |
| Investigator | 0 | Average of MEDSOL | | | |
| Investigator | 0 | Average of KX | 2.00 | 0.00 | |
| Investigator | 0 | Average of RECRUIT | 4.00 | 0.00 | |
| Investigator | 0 | Average of COACH | | | |
| Investigator | 0 | Average of REL | 3.00 | 0.00 | |
| Investigator | 0 | Average of NET | | | |
| Investigator | 0 | Average of ASSESS | | | |
| Investigator | 1 | Average of BUSSOL | | | |
| Investigator | 1 | Average of MEDSOL | | | |
| Investigator | 1 | Average of KX | 1.00 | 0.00 | |
| Investigator | 1 | Average of RECRUIT | 1.00 | 0.00 | |
| Investigator | 1 | Average of COACH | | | |
| Investigator | 1 | Average of REL | 3.00 | 0.00 | |
| Investigator | 1 | Average of NET | 1.00 | 0.00 | |
| Investigator | 1 | Average of ASSESS | 1.00 | 0.00 | |
| Investigator | 2 | Investigator Average of BUSSOL | | | |
| Investigator | 2 | Investigator Average of MEDSOL | | | |
| Investigator | 2 | Investigator Average of KX | 1.60 | 0.49 | S − |
| Investigator | 2 | Investigator Average of RECRUIT | 2.80 | 1.47 | S − |
| Investigator | 2 | Investigator Average of COACH | | | |
| Investigator | 2 | Investigator Average of REL | 3.00 | 0.00 | NS |
| Investigator | 2 | Investigator Average of NET | 1.00 | 0.00 | S + |
| Investigator | 2 | Investigator Average of ASSESS | 1.00 | 0.00 | S + |
| Prescriber | 0 | Average of BUSSOL | | | |
| Prescriber | 0 | Average of MEDSOL | | | |
| Prescriber | 0 | Average of KX | 3.00 | 0.00 | |
| Prescriber | 0 | Average of RECRUIT | | | |
| Prescriber | 0 | Average of COACH | | | |
| Prescriber | 0 | Average of REL | 4.00 | 1.00 | |
| Prescriber | 0 | Average of NET | 1.00 | 0.00 | |
| Prescriber | 0 | Average of ASSESS | | | |
| Prescriber | 1 | Average of BUSSOL | | | |
| Prescriber | 1 | Average of MEDSOL | 1.00 | 0.00 | |
| Prescriber | 1 | Average of KX | 1.57 | 0.90 | |
| Prescriber | 1 | Average of RECRUIT | | | |
| Prescriber | 1 | Average of COACH | | | |
| Prescriber | 1 | Average of REL | 3.00 | 0.00 | |
| Prescriber | 1 | Average of NET | 1.00 | 0.00 | |
| Prescriber | 1 | Average of ASSESS | | | |
| Prescriber | 2 | Prescriber Average of BUSSOL | | | |
| Prescriber | 2 | Prescriber Average of MEDSOL | 1.00 | 0.00 | S + |
| Prescriber | 2 | Prescriber Average of KX | 1.89 | 0.99 | S − |
| Prescriber | 2 | Prescriber Average of RECRUIT | | | |
| Prescriber | 2 | Prescriber Average of COACH | | | |
| Prescriber | 2 | Prescriber Average of REL | 3.22 | 0.63 | NS |
| Prescriber | 2 | Prescriber Average of NET | 1.00 | 0.00 | NS |
| Prescriber | 2 | Prescriber Average of ASSESS | | | |
| Speaker | 0 | Average of BUSSOL | | | |
| Speaker | 0 | Average of MEDSOL | | | |
| Speaker | 0 | Average of KX | 1.00 | 0.00 | |
| Speaker | 0 | Average of RECRUIT | 2.00 | 0.00 | |
| Speaker | 0 | Average of COACH | | | |
| Speaker | 0 | Average of REL | 2.83 | 0.37 | |
| Speaker | 0 | Average of NET | | | |
| Speaker | 0 | Average of ASSESS | | | |
| Speaker | 1 | Average of BUSSOL | | | |
| Speaker | 1 | Average of MEDSOL | | | |
| Speaker | 1 | Average of KX | 3.00 | 0.00 | |
| Speaker | 1 | Average of RECRUIT | 1.00 | 0.00 | |
| Speaker | 1 | Average of COACH | 1.00 | 0.00 | |
| Speaker | 1 | Average of REL | 3.00 | 0.00 | |
| Speaker | 1 | Average of NET | | | |
| Speaker | 1 | Average of ASSESS | | | |
| Speaker | 2 | Speaker Average of BUSSOL | | | |
| Speaker | 2 | Speaker Average of MEDSOL | | | |
| Speaker | 2 | Speaker Average of KX | 1.67 | 0.94 | S + |
| Speaker | 2 | Speaker Average of RECRUIT | 1.67 | 0.47 | S − |
| Speaker | 2 | Speaker Average of COACH | 1.00 | 0.00 | S + |
| Speaker | 2 | Speaker Average of REL | 2.89 | 0.31 | NS |
| Speaker | 2 | Speaker Average of NET | | | |
| Speaker | 2 | Speaker Average of ASSESS | | | |
| Total Average of BUSSOL | | | | | |
| Total Average of MEDSOL | | | 1.00 | 0.00 | |
| Total Average of KX | | | 2.26 | 1.15 | |
| Total Average of RECRUIT | | | 1.93 | 0.93 | |
| Total Average of COACH | | | 1.00 | 0.00 | |
| Total Average of REL | | | 2.95 | 0.71 | |
| Total Average of NET | | | 1.00 | 0.00 | |
| Total Average of ASSESS | | | 1.00 | 0.00 | |

For Outcome Achieved:
No = 0
Yes = 1
Combined Data = 2
Significance (significant effect defined as the difference between the means is greater than the sum of the combined StdDevPs; if the StdDevP = 0, then use the Combined StdDevP instead):
NS = Non-Significant
S − = Significant Negative Result (may be confounded)
S + = Significant Positive Result

Formulary Supporter 2 Formulary Supporter Average of COACH

Survey Analysis

Another source of performance information is the use of a survey designed to evaluate customer perception of the value of the MSL team. The survey methodology of the present invention measures physician perception along multiple dimensions, allowing the results to be used in operational management, as well as an indicator of the MSL team's progress over time. The data from the surveys, in combination with the quantitative activity data, is useful in identifying adjustments needed to optimize MSL team size, structure, and strategy. The survey method incorporates questions that allow for the identification of the most valued MSL activities. The activities most valued by the targeted customer are likely to be the most effective activities for increasing brand advocacy.

Survey Architecture

The survey method is a tool for measuring brand advocacy among targeted MTLs and the perceived quality and utility of the MSL role. Further, this method is used to measure brand advocacy and the perceived value of the MSL organization within the MSL customer universe. The results obtained from the MSL customer universe can then be compared to the pharmaceutical company's overall customer universe to assess the value added to pharmaceutical company by the MSL organization. The MSL customer universe is defined by the collective Targeted Customer Lists (TCL) for all MSLs of the company. Although multiple attributes are considered for the inclusion of a physician in a TCL, they can generally be considered MTLs.

Specifically, this survey method is designed to obtain and integrate multidimensional physician perception data into a quantitative index that is a relevant predictor of physician perceptions. The index integrates the perception dimensions of customer satisfaction, product value, MSL value, and customer service into a quantitative value. The sub-group of physicians that respond “very satisfied” to all perception dimensions under a categorical scale are labeled Brand Advocates. The positive effects of strong brand advocacy on a company's commercial success are a well-established tenet in marketing. Thus, the index provides a quantitative measure of a MSL organization's contribution to its parent company's commercial success. Since the questions are categorized according to MSL activity type, the index can be used as a business metric to assess organizational performance and identify areas in need of improvement.

The index is used as a rating of the relative perceived importance of categories of MSL activities. These categories are: MSL-Physician Interactions, Educational Funding, and Knowledge Exchange. This ranking function allows the index to be used in tactical business planning.

Survey Methodologies

Depending upon resources and/or survey methodologies utilized, all TCL physicians can be surveyed (mailed/paper-based surveys) or a random sample of MSL TCL physicians can be surveyed (telephone surveys). Each survey methodology has its advantages and disadvantages (inconvenience of timing of the call, low return rate, etc.). Given an estimated 5% return rate for a mailed survey, this data gathering methodology will provide a sufficient number of evaluable respondents, provided the customer universe is not unusually small (less than 500 targeted customers). Since most MSL groups interact with more than 500 physicians, even if the return rate is lower than 5%, the mailed survey methodology may still be the most cost-effective and provide a sufficient number of respondents upon which to base the analysis of the data.

The questions comprising the survey are designed to assess satisfaction for each of the categories of MSL activities, organized into perception dimensions of Customer Satisfaction (C), Product Value (P), MSL Value (M), and Customer Service (S), and the answers are categorized according to: Very Satisfied (1.00), Satisfied (0.75), Neutral (0.50), and Dissatisfied (0.00); or Strongly Disagree (0.00), Disagree (0.50), Agree (0.75), Strongly Agree (1.00), depending upon the context of the question.

The mean score from all respondents on all perception dimensions comprises the index converted to a decimal. Multiple sub-analyses are performed according to the way the questions are categorized. The questions are preferably designed to fit into each of two categories: MSL Activity Type and Customer Perception Dimension. The questions also focus on attributes that can be acted upon by the MSL organization.

Below are listed the exemplary questions categorized according to MSL Activity Type and to their relationship to the identified perception dimension, represented as C, P, M or S as discussed above. In addition, a corresponding response value has been added.

### EXAMPLE 6

MSL-Physician Interactions Questions

| | Perception | Response |
|---|---|---|
| Question | Dimension | Data |
| MSL is trustworthy | S | 0.5 |
| MSL is considerate of your time and | S | 0.5 |
| practice | | |
| MSL is not “pushy” | S | 0.0 |
| MSL relationship with you and your staff | C | 0.75 |
| MSL is a trusted source of information | M | 0.0 |
| regarding products and the disease | | |
| states related to their use | | |
| MSL provides services valuable to your | M | 0.5 |
| practice | | |
| MSL calls on you frequently enough | S | 0.5 |

Educational Funding Questions

| | Perception | Response |
|---|---|---|
| Question | Dimension | Data |
| Educational support was not promotional | C | 1.0 |
| Educational support was convenient | S | 1.0 |
| Educational support meets the needs of | C | 0.75 |
| your practice | | |
| Speakers provided were valued | C | 0.75 |
| sources of credible information | | |
| Educational support provided has had | M | 0.5 |
| an impact on the way you practice | | |
| medicine | | |

Knowledge Exchange Questions

| | Perception | Response |
|---|---|---|
| Question | Dimension | Data |
| Information provided was not too promotional | C | 0.75 |
| Information provided was relevant | C | 0.5 |
| Information provided has had an impact | M | 0.5 |
| on your medical practice | | |
| Information was provided in a timely manner | S | 0.5 |
| Information provided demonstrated a | C | 0.75 |
| high caliber of scientific knowledge | | |

Product Satisfaction Questions

| | Perception | Response |
|---|---|---|
| Question | Dimension | Data |
| Product(s) is/are safe to prescribe | P | 1.0 |
| Product(s) is/are effective | P | 1.0 |
| Product(s) is/are easy to dose optimally | P | 1.0 |
| MSL provides information that allows | M | 0.75 |
| for optimal use of product(s), improving | | |
| product satisfaction | | |
| Product(s) is/are adequately covered by | P | 0.75 |
| most health plans | | |
| Knowledge provided to you by the MSL | M | 0.5 |
| has enabled you to use the products | | |
| appropriately | | |

Analyses

The index is used in a number of different analyses, mostly differentiated by predefined criteria for categorizing questions and categorization of respondents based on overall index score. For example, the mean index sub-score for each of the MSL Activity Type categories may be used to identify areas of excellence as well as areas in need of improvement. These analyses may be driven down to the level of an individual question from which a specific activity can be targeted and assessed.

Using the example above, the average score of all of the responses is 0.64, obtained by taking the total value of all responses 14.75 and dividing by the number of questions 23. This illustrates the customers evaluation of all the services provided in the example is between neutral (0.5) and satisfied (0.75).

Further, each activity may be evaluated to find the strengths and weaknesses of the MSL. Again using the example above, the average score for product satisfaction is 0.85 confirming a high approval rating. Conversely, the average score of MSL-Physician Interactions is 0.39 illustrating a low approval rating. Moreover, the score may be based on the perception dimension of customer satisfaction. For example, all of the perception dimensions combined will equal 0.64 as calculated for the MSL activities above. However, the score for customer satisfaction is 0.75 corresponding to a satisfactory rating.

This survey method and feedback is used to improve and modify the activities of the MSL and to increase customer approval and efficiency of the MSL. Specifically, the survey results may be used to modify other components of the method to obtain the desired business goal of the sponsor company. Eventually, by continuous cyclic repetition of the method, the average score of the entire survey and of particular activity and perception groups will rise to near the 1.0 “very satisfied” rating.

Value Provided

In order to perform analyses of the perceived value added by the MSL organization, the MSL customer universe can be subdivided into those physicians on whom only MSLs call and those physicians on which both MSLs and the company's traditional sales force call. Comparisons of survey scores and business outcomes (script volume and market share) can then be made between these groups and to the entire physician population in order to examine the relationship of index scores to increased brand advocacy. These measures can then be tracked over multiple assessments and the information used to allocate resources among the categories of MSL activities, change MSL practices, and improve the MSL organization's business model through the enabling of continuous business improvements.

The system of the present invention permits the user to normalize data to headcount for trend analyses since the anticipated sharp increase in recorded activities resulting from addition of new MSLs may make projections inaccurate. The absolute numbers will also be available, enabling senior management to determine their ROI in the MSL team.

Effective implementation of MSL team activities will facilitate the appropriate use of the sponsor company's products. The above-described business system and methods provides the information needed to maximize effectiveness of the MSL team.

Business Management Tools/Scorecards

Returning to the example in the execution phase of Dr. John Know, a review of the activities and time spent with MTL Adams may illustrate the needed activities and time to achieve the business outcome of investigator with MTL Philbin. Thus, a feedback system is established to guide the modification of the activities and time spent in the “subsequent” planning phase with any MTL to obtain the desired business outcome. This method can be applied to any objective discussed above in the attribute system to obtain the desired business outcomes, i.e. more publications, presentations, investigation or higher amount of prescriptions written, depending on the sponsor company's objective.

Further, as discussed above the time/capacity model can be modified based on the information obtained performing the attribute and CRM assessment. For example, the MSLs may be encouraged to input their activities into the CRM tool on a weekly basis (e.g., by Friday 5 PM Pacific Time), and strongly encouraged to input their activities more frequently (2 times per week). In addition to the regular weekly reporting, it is also desirable to input activities into the CRM on the last working day of the reporting period (the regular weekly input of activities can substitute for this if performed on the last business day of the reporting period).

Although this invention has been illustrated by specific embodiments, it is not intended that the invention be limited to these embodiments. It will be apparent to those skilled in the art that various changes and modifications may be made which clearly fall within the scope of the invention. The invention is intended to be protected broadly within the spirit and scope of the appended claims.

What is claimed is:

1. A method of ranking a plurality of health professionals in a preferred order, comprising:
determining a first attribute value for each of the plurality of health professionals;
determining a second attribute value for each of the plurality of health professionals;
calculating a weighted score for each of the plurality of professionals at least based in part on the first attribute value, a first attribute weight, the second attribute value, and a second attribute weight;
ordering the health professionals in accordance with the weighted score of each of the plurality of health professionals.

2. The method of claim 1, wherein determining the first attribute value comprises determining a first normalized value associated with each of the plurality of health professionals and corresponding to one of a magnitude of clinical investigations, a magnitude of commercial potential, a frequency of publications, or a frequency of presentations and a value of another attribute.

3. The method of claim 2, wherein determining the second attribute value comprises determining a second normalized value associated with each of the plurality of health professionals and corresponding to another one of the magnitude of clinical investigations, the magnitude of commercial potential, the frequency of publications, a frequency of presentations and the value of another attribute.

4. The method of claim 1, wherein determining the first attribute value comprises at least one of retrieving the first attribute value and normalizing a first raw-data value.

5. The method of claim 4, wherein determining the second attribute value comprises at least one of retrieving the second attribute value and normalizing a second raw-data value.

6. The method of claim 5, comprising:
multiplying the first attribute value by the first attribute weight to determine a first weighted component;
multiplying the second attribute value by the second attribute weight to determine a second weighted component; and
adding the first weighted component to the second weighted component to determine at least part of the weighted score.

7. The method of claim 6, comprising:
determining at least one additional weighted component; and
adding the at least one additional weighted component to the at least part of the weighted score to determine the weighted score.

8. The method of claim 1, wherein ordering the health professionals comprises ordering the health professionals in the preferred order.

9. The method of claim 8, comprising ordering the health professionals in a pre-defined order.

10. The method of claim 8, comprising dynamically altering at least one of the first attribute weight and the second attribute weight in accordance with the preferred order.

11. A method of ranking a plurality of health professionals in a preferred order, comprising:
determining a first normalized value associated with each of the plurality of health professionals and corresponding to one of a magnitude of clinical investigations, a magnitude of commercial potential, a frequency of publications, frequency of presentations and a value of another attribute.
determining a second normalized value associated with each of the plurality of health professionals and corresponding to another one of the magnitude of clinical investigations, the magnitude of commercial potential, the frequency of publications, frequency of presentations and the value of another attribute.
multiplying each of the first normalized values by a first weight to determine a first weighted component for each of the plurality of health professionals;
multiplying each of the second normalized values by a second weight to determine a second weighted component for each of the plurality of health professionals;
adding the first weighted component to the second weighted component to determine at least part of a weighted score for each of the plurality of health professionals; and
ordering the health professionals in accordance with the weighted score of each of the plurality of health professionals.

12. The method of claim 11, comprising:
determining at least one additional weighted component; and
adding the at least one additional weighted component to the at least part of the weighted score to determine the weighted score.

13. The method of claim 11, wherein determining the first normalized value comprises at least one of retrieving the first normalized value and normalizing a first raw-data value.

14. The method of claim 13, wherein determining the second normalized value comprises at least one of retrieving the second normalized value and normalizing a second raw-data value.

15. The method of claim 11, wherein ordering the health professionals comprises ordering the health professionals in the preferred order.

16. The method of claim 15, comprising ordering the health professionals in a pre-defined order.

17. The method of claim 15, comprising dynamically altering at least one of the first weight and the second weight in accordance with the preferred order.

18. A method for prioritizing and selecting health professional customers to be targeted for interaction with medical liaison personnel to achieve desired business outcomes, the method comprising:
defining a plurality of business outcome attributes corresponding to the desired business outcomes;
determining an attribute value for each identified business outcome attribute for each of a plurality of individual health professional customers;
assigning a relative weight to each of the business outcome attributes; and
ordering the individual health professional customers based upon the attribute values of the customers and the relative weight of the business outcome attributes.

19. The method of claim 18, wherein at least one of the business outcome attributes is selected from the group consisting of a magnitude of clinical investigations, a magnitude of commercial potential, a frequency of publications, and a frequency of presentations.

20. A method for managing customer interaction activities of medical liaison personnel of a sponsor organization with health professional customers, the method comprising:
identifying one or more desired business outcomes;
identifying one or more activity attributes of customer interaction activity to be performed by the medical liaison personnel;
recording data regarding customer interaction activity of the medical liaison personnel for a predetermined time period;
recording data regarding the business outcomes achieved or not achieved during the predetermined time period; and
correlating the customer interaction activity data and the business outcome data.

21. The method of claim 20, wherein at least one of the desired business outcomes is an activity by the customer selected from the group consisting of publishing of a medical article, conducting a clinical investigation, attending a formulary meeting, speaking on a medical topic, and prescribing a pharmaceutical product to a predetermined level.

22. The method of claim 20, wherein at least one of the activity attributes is selected from the group consisting of facilitating the ability of a customer to utilize a sponsor product, improving a customer's disease management practice, exchanging scientific information with a customer, coaching a customer for a presentation, interacting with a customer on a social basis, facilitating interactions between customers, and investigating potential clinical investigation sites.

23. The method of claim 20, wherein the recorded customer interaction data corresponds to time, frequency, duration or sequence data for customer interaction activities.

24. The method of claim 20, wherein the method comprises:
assessing the capacity of the medical liaison personnel of the sponsor organization to perform the desired business objectives within the predetermined time period

25. The method of claim 20, wherein the method comprises:
evaluating the business outcomes achieved or not achieved relative to the customer interaction activities performed within the predetermined time period to determine improved customer interaction activity allocation for achieving future desired business outcomes.

26. The method of claim 20, wherein the method further comprises:
conducting a survey of the health professional customers to determine customer satisfaction with the customer interaction activities performed by the medical liaison personnel.

27. A system for managing customer interaction activities of medical liaison personnel of a sponsor organization with health professional customers to achieve one or more desired business outcomes, the system comprising:
a customer relation database;
means for defining one or more activity attributes of customer interaction activity to be performed by the medical liaison personnel associated with the customer relation database;
means for recording data regarding customer interaction activity of the medical liaison personnel for a predetermined time period into the customer relation database;
means for recording data regarding the business outcomes achieved or not achieved during the predetermined time period into the customer relation database; and
means for correlating the customer interaction activity data and the business outcome data.

28. The system of claim 27, wherein at least one of the desired business outcomes is an activity by the customer selected from the group consisting of publishing of a medical article, conducting a clinical investigation, attending a formulary meeting, speaking on a medical topic, and prescribing a pharmaceutical product to a predetermined level.

29. The system of claim 27, wherein at least one of the activity attributes is selected from the group consisting of facilitating the ability of a customer to utilize a sponsor product, improving a customer's disease management practice, exchanging scientific information with a customer, coaching a customer for a presentation, interacting with a customer on a social basis, facilitating interactions between customers, and investigating potential clinical investigation sites.

30. The system of claim 27, wherein the recorded customer interaction data corresponds to time, frequency, duration or sequence data for customer interaction activities.

31. A method of facilitating a desired business outcome of a sponsor organization, comprising:
identifying a past business interaction having a past business outcome at least similar to the desired business outcome; and
identifying a plurality of customer-relations values each corresponding to one of a plurality of customer-relations attributes associated with the past business interaction.

32. The method of claim 31, comprising defining each of the customer-relations attributes as one of interaction date, name, activity type, duration of interaction, and business outcome type.

33. The method of claim 31, wherein identifying the past business interaction comprises querying a database with at least one of MSL, MTL, business outcome type, and activity type.

34. The method of claim 31, wherein identifying the past business interaction comprises identifying a past interaction having an outcome value representative of at least one of a favorable past business outcome and an unfavorable past business outcome, the past business interaction having a past business outcome equal to the desired business outcome.

35. The method of claim 31, wherein identifying the past business interaction comprises identifying an interaction having an outcome value representative of a level of favorability within a range.

36. The method of claim 31, comprising communicating the plurality of customer-relations values to at least one of a user and a computer program.

37. The method of claim 31, comprising documenting the past business outcome and at least one of the plurality of customer-relations values and the information represented by the plurality of customer-relations values.

38. The method of claim 31, comprising communicating information represented by the plurality of customer-relations values to at least one of a user and a computer program.

39. The method of claim 38, comprising defining each of the customer-relations attributes as one of interaction date, name, activity type, duration of interaction, and business outcome type.

40. The method of claim 38, wherein identifying the past business interaction comprises querying a database with at least one of MSL, MTL, business outcome type, and activity type.

41. The method of claim 38, wherein identifying the past business interaction comprises identifying a past interaction having an outcome value representative of at least one of a favorable past business outcome and an unfavorable past business outcome, the past business interaction having a past business outcome equal to the desired business outcome.

42. The method of claim 38, wherein identifying the past business interaction comprises identifying an interaction having an outcome value representative of a level of favorability within a range.

43. The method of claim 38, comprising communicating the plurality of customer-relations values to at least one of a user and a computer program.

44. The method of claim 38, comprising communicating information represented by the plurality of customer-relations values to at least one of a user and a computer program.

45. The method of claim 38, comprising documenting the past business outcome and at least one of the plurality of customer-relations values and the information represented by the plurality of customer-relations values.

46. A method for assessing health professional satisfaction with medical liaison and sponsor organization performance, the method comprising:
defining one or more medical liaison attributes;
defining one or more health professional perception attributes;
presenting a survey to a plurality of health professional having one or more survey questions associated with the defined medical liaison attributes and the defined perception attributes; and
recording the survey responses of responding health professionals.

47. The method of claim 46, comprising assigning a relative satisfaction value to the survey responses

48. The method of claim 46, comprising evaluating the survey responses relative to the medical liaison attributes, health professional perception attributes, or a combination thereof.

49. The method of claim 48, comprising adjusting plans for future medical liaison activity based on the evaluated survey responses.

50. The method of claim 46, wherein at least one of the medical liaison performance attributes is selected from the group consisting of medical liaison-health professional interaction, educational funding and knowledge exchange, and product satisfaction.

51. The method of claim 46, wherein at least one of the health professional perception attributes is selected from the group consisting of customer satisfaction, product value, medical liaison value and customer service.
